(19) United States
(12) Patent Application Publication
(10) Pub. No.: US 2016/0127657 A1
(43) Pub. Date: May 5, 2016

(54) IMAGING SYSTEM

(71) Applicant: SHARP KABUSHIKI KAISHA, Osaka (JP)

(72) Inventors: Shigeki MUKAI, Osaka-shi (JP); Yasutaka WAKABAYASHI, Osaka-shi (JP); Kenichi IWAUCHI, Osaka-shi (JP)

(21) Appl. No.: 14/895,259

(22) PCT Filed: May 20, 2014
(86) PCT No.: PCT/JP2014/063273

§ 371 Date: Dec. 2, 2015

(30) Foreign Application Priority Data
Jun. 11, 2013 (JP) 2013-122548

(51) Int. Cl. H04N 5/247; G06T 7/00; G06T 7/60; G06K 9/52; H04N 5/232; G06K 9/62

(52) U.S. Cl. CPC H04N 5/247; H04N 5/23238; G06K 9/6215; G06T 7/60; G06K 9/52; G06T 7/0042; G06T 2207/30242

(57) ABSTRACT

An image-capturing system including at least three cameras with different image-capturing directions, a feature point extraction unit that extracts a feature point of a subject from images captured by the camera, and an image storage unit that stores images captured by the cameras is characterized by: a feature quantity calculation/detection unit that calculates a feature quantity of the subject from the feature point extracted by the feature point extraction unit; a direction estimation unit that estimates a direction in which the subject is oriented from the feature point extracted by the feature point extraction unit; and a stored camera image determination unit that determines a camera image to be stored in the image storage unit, wherein, when a difference between the feature quantity calculated by the feature quantity calculation unit and a particular feature quantity set in advance is not more than a certain value, the stored camera image determination unit determines, as a first stored image, the image from which the feature point has been extracted by the plurality of the feature point extraction unit, and determines a second stored image by identifying a camera in accordance with the direction in which the subject is oriented as estimated by the direction estimation unit from the feature point extracted in the first stored image.

### TECHNICAL FIELD

The present invention relates to a image-capturing technology for photographing a subject using a plurality of cameras.

### BACKGROUND ART

Conventionally, as a system for photographing a subject using a plurality of cameras, a surveillance camera system has been proposed including a plurality of cameras installed in a facility, such as a shop or a theme park, so as to take and store images in the facility, or to display the images on a display device for crime prevention purposes, for example. A system is also known that includes a plurality of cameras installed in a home for the elderly or a nursery for the purpose of confirming or monitoring how the elderly or children are doing on a daily basis.

In such systems, because the cameras perform image acquisition or recording for a long time, confirming all of the images would require a great amount of time and would therefore be difficult. Thus, there is a need for confirming only an image of a particular timing without confirming images in which no event, i.e., no change, is taking place. The particular images are, for example, images around the time of a crime committed in the case of a surveillance camera, or images capturing the activity of a particular person in the case of monitoring. For the purpose of watching over children, for example, a guardian may want to monitor a child, and there is a particular need for images of points in time when some event occurred, such as the child smiling or crying.

To address such needs for extracting the images of particular timing from images for an extended period of time or from a large number of images, various functions have been proposed, such as follows.

In Patent Literature 1 indicated below, a digest image generation device is proposed whereby short-time images for learning the activities of a person or an object are automatically created from images recorded by one or more image-capturing devices. The person or object is fitted with a wireless tag, the overall position of the person or object is known using a wireless tag receiver, and it is determined by which image-capturing device the person or object was photographed in what time band so as to extract images capturing the person or object from the images taken by a plurality of image-capturing devices. Then, the extracted images are divided at certain unit time intervals, and an image feature amount is computed on a unit image basis to identify what event (occurrence) was taking place and thereby generate digest images.

Patent Literature 2 indicated below proposes an image-capturing device, an image-capturing method, and a computer program for performing preferable photography control on the basis of a mutual relationship of the results of facial recognition of a plurality of persons. From each subject, a plurality of facial recognition parameters are detected, such as the level of smile, position in the image frame, inclination of the detected face, and attributes of the subject such as sex. Based on the mutual relationship of the detected facial recognition parameters, photography control is implemented, including the shutter timing determination and the self-timer setting, thereby enabling the acquisition of a preferable image for the user on the basis of the mutual relationship of the results of facial recognition of a plurality of persons.

Patent Literature 3 indicated below proposes an image processing device and image processing program for accurately extracting a scene in which a large number of persons are closely observing the same object in an image including the plurality of persons as subjects. The lines of sight of the plurality of persons are estimated, and the distances to the plurality of persons whose lines of sight have been estimated are calculated. Based on the result of the line-of-sight estimation and the distance calculation result, it is determined whether the lines of sight of the plurality of persons are intersecting so as to accurately extract the scene in which a large number of persons are closely observing the same object based on the determination result.

### CITATION LIST

### Patent Literature

Patent Literature 1: JP 2012-160880 A
Patent Literature 2: JP 2010-016796 A
Patent Literature 3: JP 2009-239347 A

### SUMMARY OF INVENTION

### Technical Problem

While various functions have been proposed as described above to address the need for extracting an image of a particular timing from images, there are the following problems.

In the device described in Patent Literature 1, the particular person or object is extracted using a wireless tag, and a digest image is generated by identifying what event is taking place at certain time intervals. Specifically, a single camera image showing the person or object is extracted from a plurality of cameras for event analysis. Accordingly, the device enables the analysis of events such as eating, sleeping, playing, or a collective behavior. However, the device may not enable the determination of more detailed events, such as what a kindergarten pupil is showing an interest in during a particular event such as mentioned above, due to failure to store images of an object the person is paying attention to depending on the camera angle or position.

In the device described in Patent Literature 2, photography control such as shutter timing determination and self-timer setting is implemented based on the mutual relationship of facial recognition parameters. However, even if an image is taken at the timing of the subject person smiling, for example, it cannot be accurately known what the object of attention of the person was that induced the person to smile.

Similarly, in the device described in Patent Literature 3, while an image of the scene in which a large number of persons are closely observing the same object can be extracted from images including the plurality of persons as the subjects, it cannot be determined later from the image what the object of the close observation was.

The present invention was made to solve the aforementioned problems, and an object of the present invention is to provide an image-capturing technology that enables more detailed recognition of a situation or event at the point in time of taking an image.

### Solution to Problem

According to an aspect of the present invention, there is provided an image-capturing system including at least three cameras with different image-capturing directions, a feature point extraction unit that extracts a feature point of a subject from images captured by the cameras, and an image storage unit that stores the images captured by the cameras, the image-capturing system further comprising: a feature quantity calculation unit that calculates a feature quantity of the subject from the feature point extracted by the feature point extraction unit; a feature point direction estimation unit that estimates a direction of the feature point detected by the feature point detection unit; and a stored camera image determination unit that determines a camera image to be stored in the image storage unit, wherein, when a difference between the feature quantity detected by the feature quantity detection unit and a particular feature quantity set in advance is not more than a certain value, the stored camera image determination unit determines, as a first stored image, the image from which the feature point has been detected by the plurality of the feature point detection unit, and determines a second stored image by identifying a camera in accordance with the feature point direction estimated by the feature point direction detection unit from the feature point extracted in the first stored image.

That at least three cameras with different image-capturing directions are disposed means that three cameras capable of capturing images in different direction are disposed. No matter how many cameras that capture images only in the same direction may be installed, an image in the direction facing the front of the subject and an image in the direction in which the subject is closely observing cannot be captured simultaneously.

The present description incorporates the contents described in the description and/or drawings of Japanese Patent Application No. 2013-122548 on which the priority of the present application is based.

### Advantageous Effects of Invention

According to the present invention, when images are later confirmed, it can be known what it was that a person saw that caused a change in the person's facial expression, whereby the situation or event at the point in time of image capturing can be recognized with greater details.

### BRIEF DESCRIPTION OF DRAWINGS

FIG. 1 is a block diagram of a configuration example of an image-capturing system according to a first embodiment of the present invention.

FIG. 2 is a diagram illustrating an installation environment of an image-capturing system according to the first embodiment of the present invention.

FIG. 3 is a lateral view of the installation environment of the image-capturing system according to the first embodiment of the present invention.

FIG. 4 is a bird's-eye view of the installation environment of the image-capturing system according to the first embodiment of the present invention.

FIG. 5 is flowchart of an operation procedure of the image-capturing system according to the first embodiment of the present invention.

FIG. 6 is a diagram illustrating an image of a person captured by the image-capturing system according to the first embodiment of the present invention.

FIG. 7 is a diagram illustrating camera arrangements of the image-capturing system according to the first embodiment of the present invention.

FIG. 8 is a diagram illustrating an image of an object captured by image-capturing system according to the first embodiment of the present invention.

FIG. 9 is a block diagram of a configuration example of an image-capturing system according to the second embodiment of the present invention.

FIG. 10 is a diagram illustrating an installation environment of the image-capturing system according to the second embodiment of the present invention.

FIG. 11 is a flowchart of an operation procedure of the image-capturing system according to the second embodiment of the present invention.

FIG. 12 is a diagram illustrating an image of a person captured by the image-capturing system according to the second embodiment of the present invention.

FIG. 13 is a diagram for describing a distance calculation method.

FIG. 14 is a block diagram of a configuration example of an image-capturing system according to the third embodiment of the present invention.

FIG. 15 is a diagram illustrating an installation environment of the image-capturing system according to the third embodiment of the present invention.

FIG. 16 is a diagram illustrating a fish-eye image captured by the image-capturing system according to the third embodiment of the present invention.

FIG. 17 is a flowchart of an operation procedure of the image-capturing system according to the third embodiment of the present invention.

FIG. 18 is a diagram illustrating an image captured by the image-capturing system according to the third embodiment of the present invention.

FIG. 19 is a block diagram of an image-capturing system according to a fourth embodiment of the present invention.

FIG. 20 is a diagram illustrating an installation environment of the image-capturing system according to the fourth embodiment of the present invention.

FIG. 21 is a lateral view of a room in which image-capturing is performed.

FIG. 22 is a bird's-eye view of the room in which image-capturing is performed.

FIG. 23 is a flowchart diagram of a process flow in the image-capturing system.

FIG. 24 is a diagram illustrating an example of a camera image taken by a first camera in the environment of FIG. 20.

FIG. 25 is a diagram illustrating camera arrangements of an image-capturing system according to the present embodiment.

FIG. 26 is a diagram illustrating an image of an object captured by the image-capturing system according to the fourth embodiment of the present invention.

### DESCRIPTION OF EMBODIMENTS

In the following, embodiments of the present invention will be described with reference to the attached drawings. While the attached drawings illustrate specific embodiments and implementation examples in accordance with the principle of the present invention, these are for facilitating an understanding of the present invention and not to be taken to interpret the present invention in a limited sense.

### First Embodiment

A first embodiment of the present invention will be described with reference to the drawings. The size and the like of the various parts illustrated in the drawings may be exaggerated in their dimensional relationships for ease of understanding and therefore different from their actual sizes.

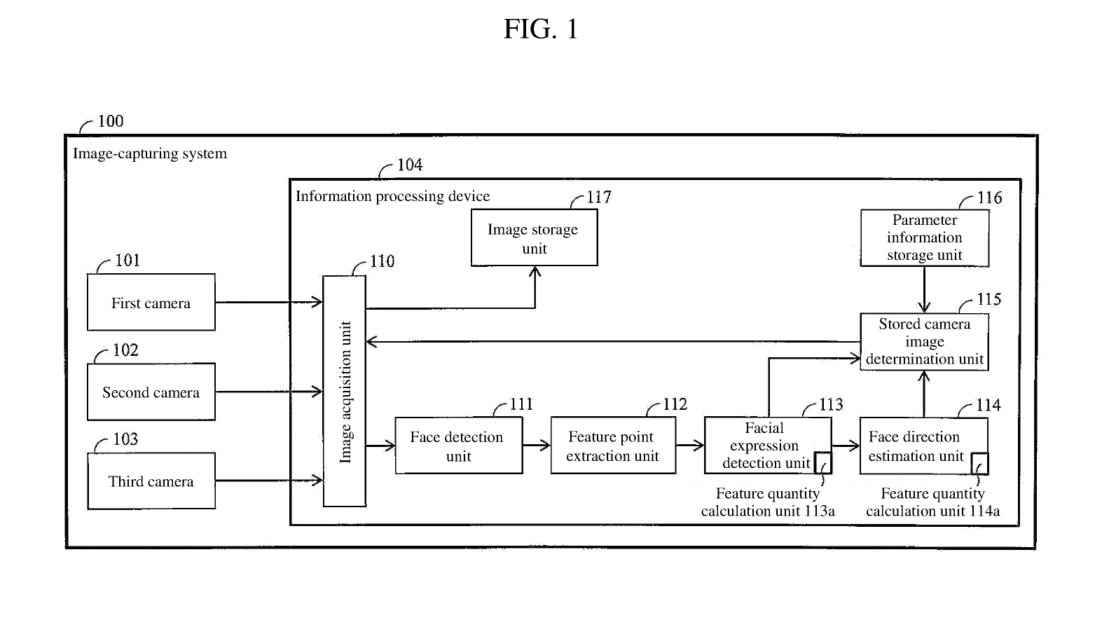

FIG. 1 is a block diagram of a configuration of an image-capturing system according to a first embodiment of the present invention. The image-capturing system 100 is configured from three cameras including a first camera 101, a second camera 102, and a third camera 103, and an information processing device 104. The information processing device 104 includes: an image acquisition unit 110 that acquires images taken by the first camera 101, the second camera 102, and the third camera 103; a face detection unit 111 that detects a human face from the images acquired by the image acquisition unit 110; a feature point extraction unit 112 that extracts a plurality of feature points from the face detected by the face detection unit 111; a facial expression detection unit 113 that detects a facial expression from a feature quantity determined from the plurality of feature points extracted by the feature point extraction unit 112; a face direction estimation unit 114 that estimates a face direction from the feature quantity determined from the plurality of feature points extracted by the feature point extraction unit 112 with respect to the face of which the facial expression has been detected by the facial expression detection unit 113; a parameter information storage unit 116 in which parameter information indicating a positional relationship of the first camera 101, the second camera 102, and the third camera 103 is stored; a stored camera image determination unit 115 that determines, as a stored camera image, an image selected in accordance with the image of which the facial expression has been detected by the facial expression detection unit 113 and the face direction estimated by the face direction estimation unit 114 and with reference to the parameter information recorded in the parameter information storage unit 116; and an image storage unit 117 that stores the image determined by the stored camera image determination unit 115.

The parameter information storage unit 116 and the image storage unit 117 may be configured from a hard disk drive (HDD) or a flash memory, a semiconductor storage device such as a dynamic random access memory (DRAM), or a magnetic storage device. In the present example, the facial expression detection unit 113 and the face direction estimation unit 114 respectively include feature quantity calculation units 113a and 114a that calculate feature quantities related to facial expression or face direction, respectively, from the plurality of feature points extracted by the feature point extraction unit 112.

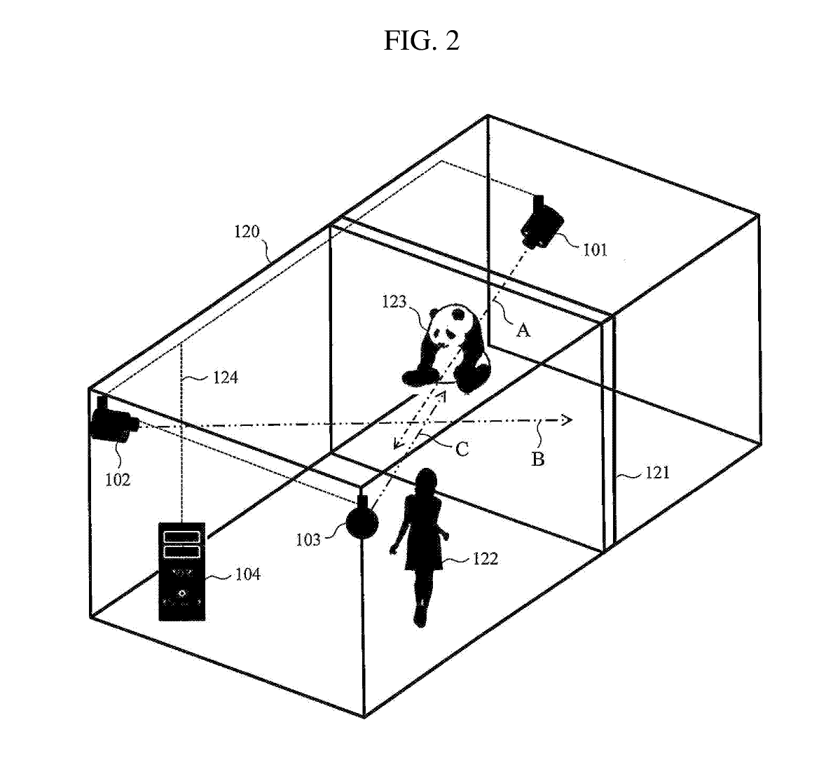

An example of the environment of use of the present image-capturing system will be described in detail with reference to FIG. 2. In FIG. 2, the image-capturing system is installed in a room 120, and the information processing device 104 is connected via a local area network (LAN) 124 to the first camera 101, the second camera 102, and the third camera 103, which are installed on the roof. In the room 120, there are a person 122 and an object 123, which in this case is an animal, with a glass board 121 installed between the person 122 and the object 123. The glass board 121 is transparent, so that the person 122 and the object 123 can see each other. The first camera 101 captures an image in a direction A where there is the person 122 through the glass board 121. The second camera and the third camera capture images in directions B and C where there is the object 123.

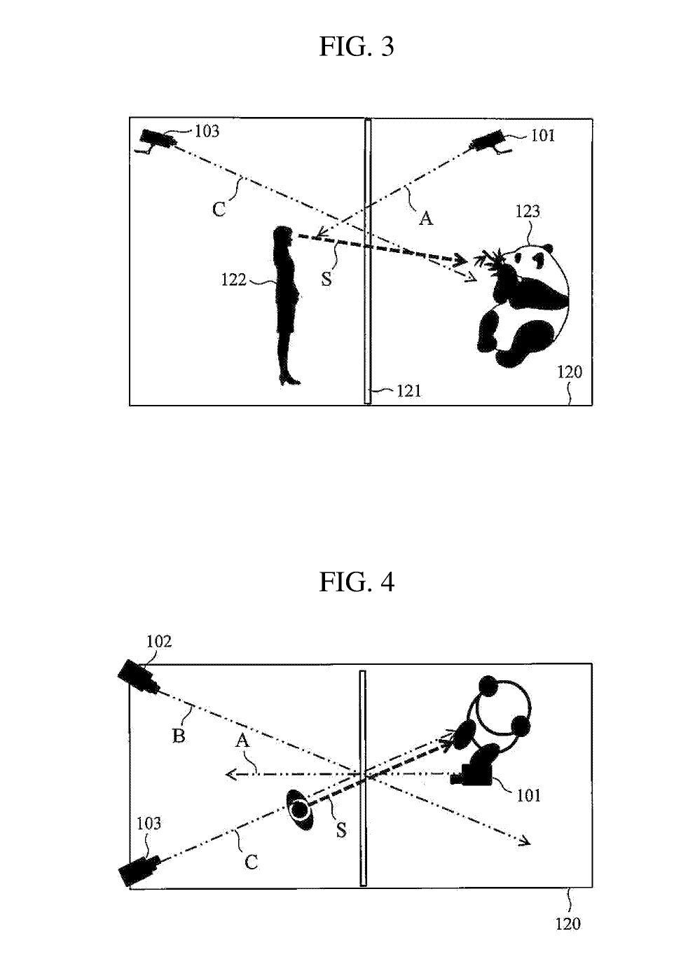

FIG. 3 is a lateral view of the room 120. FIG. 4 is a bird's-eye view of the room 120. The first camera 101, the second camera 102, and the third camera 103 are each installed so as to photograph in a downwardly inclined direction with respect to the roof of the room 120. Because the second camera 102 is installed at approximately the same height position as the third camera 103, the second camera 102 is hidden behind the third camera 103 in FIG. 3. The first camera 101 photographs in the direction A where there is the person 122 as mentioned above. Similarly, the second camera 102 and the third camera 103 respectively photograph in direction B and direction C where there is the object 123. The first camera 101 is installed approximately in parallel with the long side of the walls of the room 120. The second camera 102 and the third camera 103 are each installed inwardly with respect to each other, so that the optical axes of direction B and direction C intersect each other at a position along the long sides.

Herein, a situation is assumed in which the person 122 is watching the object 123 in a direction S through the glass board 121.

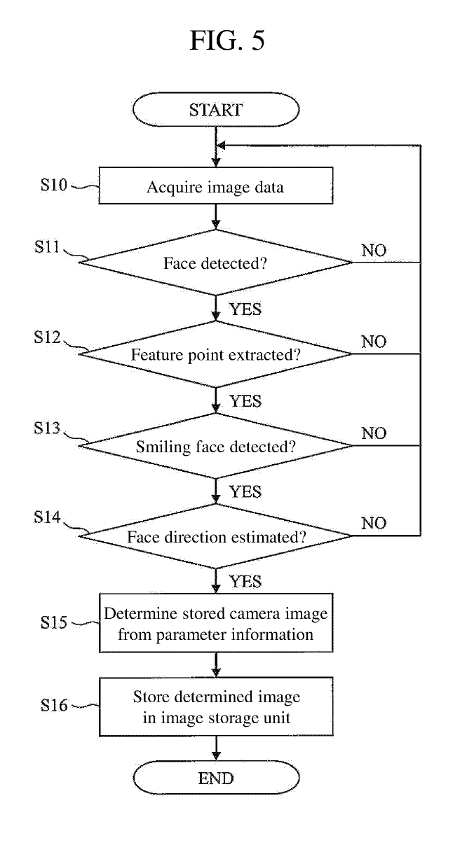

FIG. 5 is a flowchart of the flow of a process in the present image-capturing system. With reference to the flowchart, the details of the functions of the various units will be described.

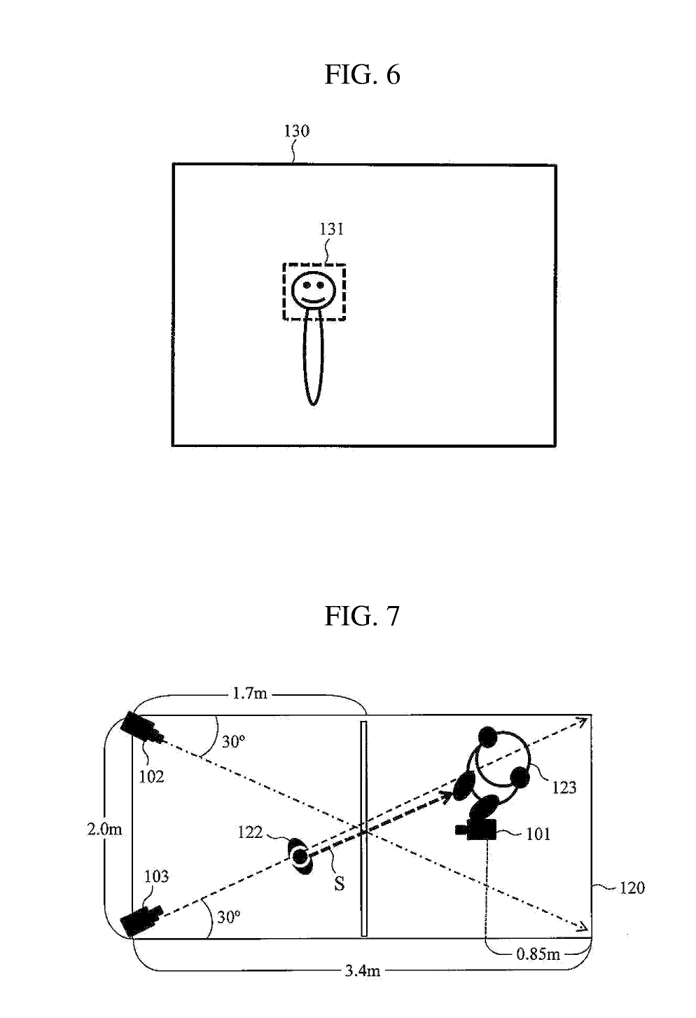

The first camera 101, the second camera 102, and the third camera 103 perform photography, and the captured images are transmitted via the LAN 124 to the image acquisition unit 110. The image acquisition unit 110 acquires the transmitted images (step S10) and temporarily retains the images in memory. FIG. 6 is a diagram illustrating an example of a camera image 130 taken by the first camera 101 in the environment of FIG. 2. The images acquired by the image acquisition unit 110 are sent to the face detection unit 111. The face detection unit 111 performs a face detection process on the camera image 130 (step S11). The face detection process includes scanning an image for face detection by sequentially moving a search window (such as a 8-pixels×8-pixels determination region) from upper-left so as to determine whether there is a region having a feature point that can be recognized as a face in each region of the search window. For such face detection method, various algorithms have been proposed, such as the Viola-Jones method. According to the present embodiment, the image for facial detection is the image taken by the first camera, and the images taken by the second camera and the third camera are not subjected to the face detection process. The result of detection by the face detection process is illustrated in a rectangular region 131 indicated by broken lines in FIG. 6. With respect to the rectangular region 131, i.e., the detected face region, the feature point extraction unit 112 determines whether a feature point has been extracted by a feature point extraction process for extracting the position of the nose, eyes, or mouth, which are facial feature points (step S12).

The feature point herein refers to the coordinates of the nose top, an eye end point, or a mouth end point. A feature quantity, as will be described later, refers to, e.g., a distance between the coordinates of a feature point itself and the coordinates calculated based on the coordinates; a relative positional relationship of the respective coordinates; or the area or brightness and the like of a region enclosed between the coordinates, for example. The plurality of types of feature quantities may be combined to obtain a feature quantity. Alternatively, the amount of displacement between a particular feature point that is set in advance in a database, which will be described later, and the position of the detected face may be calculated to provide a feature quantity value.

The facial expression detection unit 113 determines, from a plurality of feature points extracted by the feature point extraction unit 112, a feature quantity of the distance between the feature points, the area enclosed by the feature points, or a brightness distribution, and detects a smiling face by referring to a database in which the feature quantities of feature point extraction results corresponding to facial expressions acquired from the faces of a plurality of persons beforehand are gathered (step S13).

For example, the facial expression of a smiling face tends to have lifted ends of the mouth, an open mouth, or shades on the cheeks. For these reasons, it is seen that the distance between the eye end point and the mouth end point becomes smaller, the pixel area enclosed by the right and left mouth end points, the upper lip, and the lower lip increases, and the brightness value of the cheek regions is generally decreased compared with facial expressions other than that of a smiling face.

When the feature quantities in the database are referenced, it is assumed that a particular facial expression has been detected when the difference between the determined feature quantity and a particular feature quantity that has been set in the database in advance is not more than a certain value, such as 10% or less, where the feature quantity difference indicating detection may be set as desired by the user of the present system 100.

While the facial expression herein detected by the facial expression detection unit 113 is a smiling face, the facial expression according to the present invention may include characteristic human faces such as those when laughing, crying, troubled, or angered, any of which may be detected by the facial expression detection unit 113 as a facial expression. What facial expression is to be set may be set as desired by the user using the present image-capturing system 100.

Referring to FIG. 6, when the detected facial expression is a particular facial expression such as that of a smiling face, the process transitions to step S14. If the smiling face is not detected, the process returns to step S10.

By thus taking a picture only when a smiling face is present (i.e., when the expression is a particular facial expression), unnecessary image-capturing can be reduced, whereby the total volume of the captured images can be reduced.

Next, the face direction estimation unit 114 estimates, from the feature quantity determined from the position of the feature point extracted by the feature point extraction unit 112, the angle of the detected face with respect to the right and left directions (step S14). The feature quantity is similar to the one that have been described with reference to the facial expression detection unit 113. The direction of the detected face is estimated by referring to the database in which the feature quantities as the result of extraction of the feature points acquired in advance from the faces of the plurality of persons are gathered, as in the case of the facial expression detection unit 113. Herein, the estimated angle may be in an angle range of 60° for each of the left or negative angles and the right or positive angles with respect to the 0° right-left angle at which the front face is viewed from the camera. Further description of the face detection method, the facial expression detection method, and the face direction estimation method will be omitted as they involve known technologies.

The stored camera image determination unit 115 determines, as stored camera images, two camera images of the camera image detected by the facial expression detection unit 113 and the camera image determined from the face direction estimated by the face direction estimation unit 114 and by referring to the parameter information stored in the parameter information storage unit 116 and created on the basis of the positional relationship between the second camera and the third camera, indicating the correspondence between the face direction and the image-capturing camera (step S15). Hereafter, the camera image detected by the facial expression detection unit 113 will be referred to as a first stored image, and the camera image determined by referring to the parameter information will be referred to as a second stored image.

In the following, the parameter information and a method of determining the stored camera images will be described with reference to a specific example.

TABLE 1

| 140 | 141 |
|---|---|
| Face direction | Stored image- |
| (angle) | capturing camera |
| −60 | Second camera |
| −50 | Second camera |
| −40 | Second camera |
| −30 | Second camera |
| −20 | Second camera |
| −10 | Second camera |
| 0 | Third camera |
| 10 | Third camera |
| 20 | Third camera |
| 30 | Third camera |
| 40 | Third camera |
| 50 | Third camera |
| 60 | Third camera |

The parameter information shows the corresponding relationship of the stored-image capturing camera to the face direction, as illustrated in Table 1. The parameter information is determined on the basis of the room size and the positions of the first camera 101, the second camera 102, and the third camera 103, and is created from the camera arrangement illustrated in FIG. 7 in the present example. As illustrated in FIG. 7, the room 120 is a room measuring 2.0 m in length by 3.4 m in width. The first camera 101 is positioned at 0.85 m from the right end and installed approximately parallel with the long sides of the walls. The second camera 102 and the third camera 103 are respectively installed facing inward at 30° with respect to the long sides of the walls. When the face direction of the face of the person 122 facing directly opposite the direction in which the first camera 101 is taking a picture is 0°, the corresponding relationship is set such that the stored camera image is provided by the camera image that minimizes the angle difference between an angle formed by the face direction S of the person 122 and the direction in which the second camera 102 is facing and an angle formed by the face direction S and the direction in which the third camera 103 is facing. In this way, the parameter information is created.

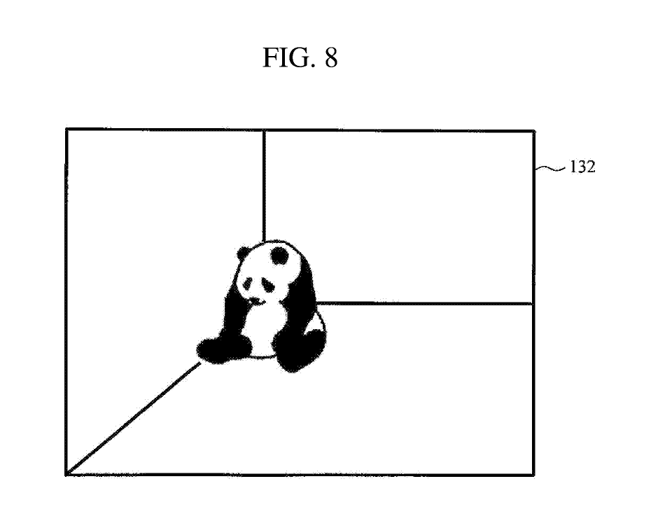

With regard to the stored camera image determination method, if the face direction estimated by the face direction estimation unit 114 in the face image captured by the first camera 101 is 30°, the third camera 103 is determined for the stored camera image with reference to the parameter information shown in Table 1. FIG. 8 illustrates a stored camera image 132 determined at this time. In the face image captured by the first camera 101, if the face direction estimated by the face direction estimation unit 114 is −60°, the second camera 102 is similarly determined for the stored camera image from Table 1. If the face direction (angle) is not shown in Table 1, the closest one of the indicated face directions is selected.

In accordance with the result determined in step S15, of the three images captured by the first camera 101, the second camera 102, and the third camera 103 and temporarily retained in memory in the image acquisition unit 110, the determined two images are transferred to the image storage unit 117 and stored therein (step S16).

Specifically, herein, the camera image 130 captured by the first camera 101 provides the first stored image, and the camera image 132 captured by the third camera 103 and showing the object of the smiling face provides the second stored image. Thus, together with the image at the point in time when the person's facial expression became a smiling face, the face direction is identified and the image captured by the camera photographing in the direction in which the person was facing provides a stored camera image. In this way, when the images are confirmed later, it can be known what caused the person to have a smiling face, thereby enabling more detailed recognition of the situation or event at the point in time of image capturing.

According to the present embodiment, together with the image at the point in time of a change in the facial expression of the subject person, the image captured by the camera photographing in the direction in which the person is facing is recorded. Thus, when the images are confirmed later, it can be known what it is that the person saw that caused a change in facial expression, enabling more detailed recognition of the situation or event at the point in time of image capturing.

In the above description of the example according to the present embodiment, the process transitions to step S14 only when the facial expression became a smiling face step S13. However, the transition is not necessarily limited to when the facial expression became a smiling face and may occur when the expression became other facial expressions.

While the example has been described in which the facial expression is used as a trigger for capturing an image, anything that can be extracted and determined as a feature quantity of the subject, such as the face angle or a gesture, may be used as the trigger.

### Second Embodiment

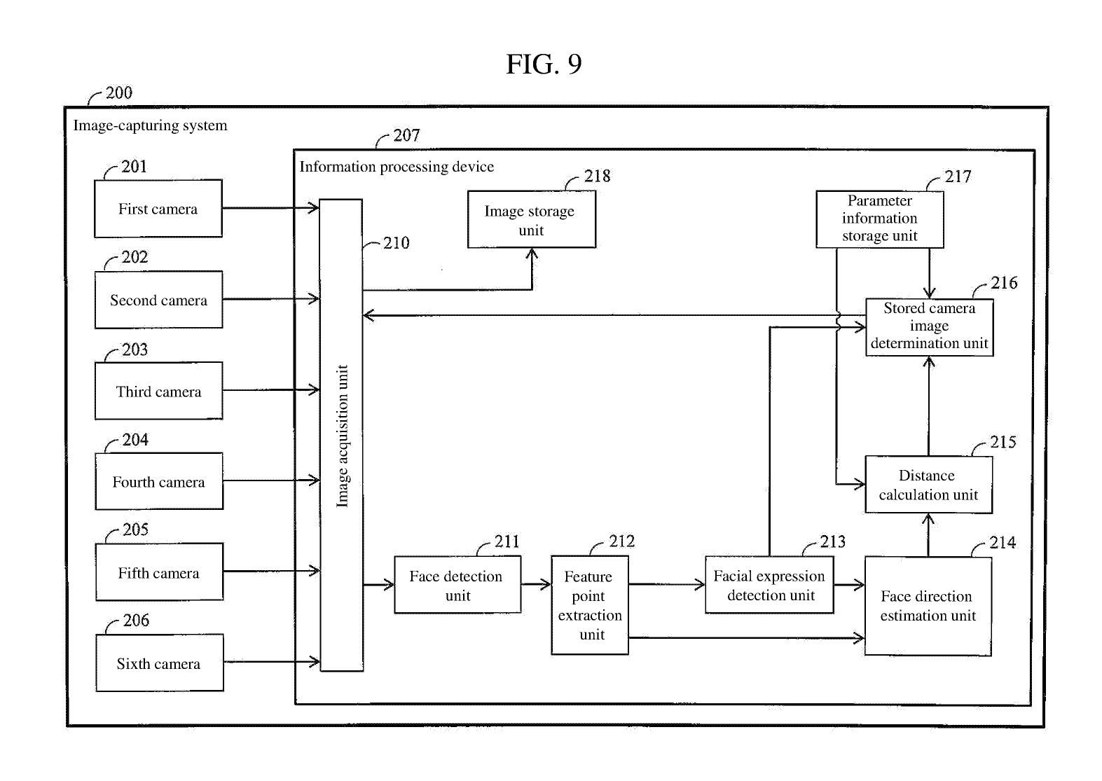

A second embodiment of the present invention will be described with reference to the drawings. FIG. 9 is a functional block diagram of a configuration of an image-capturing system according to the second embodiment of the present invention.

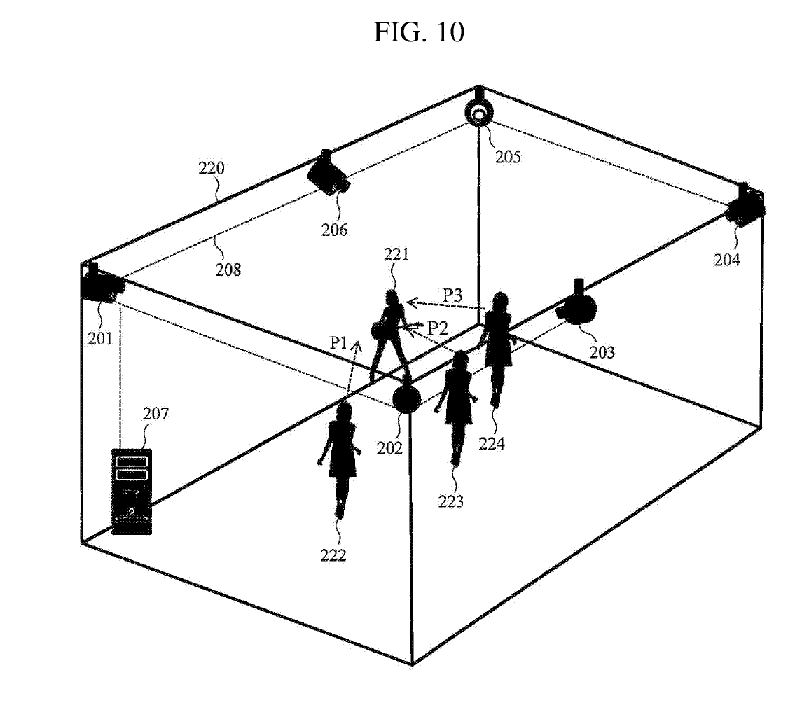

As illustrated in FIG. 9, an image-capturing system 200 is configured from six cameras including a first camera 201, a second camera 202, a third camera 203, a fourth camera 204, a fifth camera 205, and a sixth camera 206, and an information processing device 207. The information processing device 207 is configured from an image acquisition unit 210 that acquires images captured by the six cameras from the first camera 201 to the sixth camera 206; a face detection unit 211 that detects a human face from the images acquired by the image acquisition unit 210; a feature point extraction unit 212 that extracts a plurality of feature points from the face detected by the face detection unit 211; a facial expression detection unit 213 that determines feature quantities from the plurality of feature points extracted by the feature point extraction unit 212 and detects a facial expression; a face direction estimation unit 214 that estimates the face direction by determining feature quantities from the plurality of feature points extracted by the feature point extraction unit 212 with respect to the face of which the facial expression has been detected by the facial expression detection unit 213; a distance calculation unit 215 that determines whether there are persons paying attention to the same object from the face directions of the plurality of persons estimated by the face direction estimation unit 214, and that calculates the distances between the persons and the object; a stored camera image determination unit 216 that determines, as a stored camera image, a camera image determined by referring to the camera image detected by the facial expression detection unit 213, the distance calculated by the distance calculation unit 215, the face direction estimated by the face direction estimation unit 214, and the parameter information indicating the correspondence between the face direction and the image-capturing camera that has been created on the basis of the positional relationship of the six cameras from the first camera 201 to the sixth camera 206 and that is stored in the parameter information storage unit 217; and an image storage unit 218 that stores the image determined by the stored camera image determination unit 216. FIG. 10 illustrates an example of the environment of use of the present image-capturing system.

In FIG. 10, the image-capturing system is installed in a room 220, where the information processing device 207 is connected, via a local area network (LAN) 208 as in the first embodiment, to the first camera 201, the second camera 202, the third camera 203, the fourth camera 204, the fifth camera 205, and the sixth camera 206, which are respectively installed on the roof. The cameras are downwardly inclined with respect to the roof. In the room 220, there are a first person 221, a second person 222, a third person 223, and a fourth person 224. The first person 221 is drawing attention from the second person 222, the third person 223, and the fourth person 224 respectively in a face direction P1, a face direction P2, and a face direction P3.

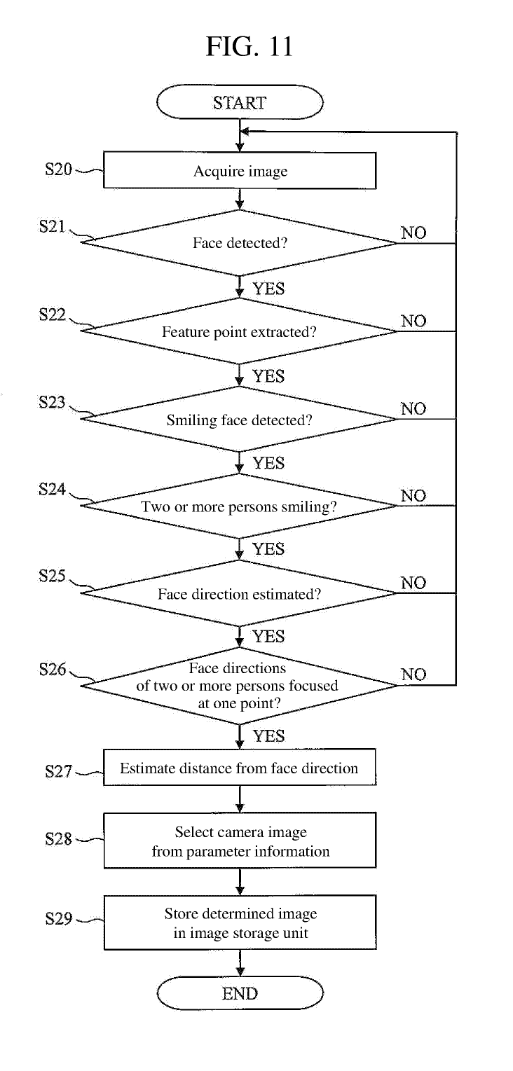

FIG. 11 is a flowchart of the flow of processing in the present image-capturing system, with reference to which the details of the various units will be described.

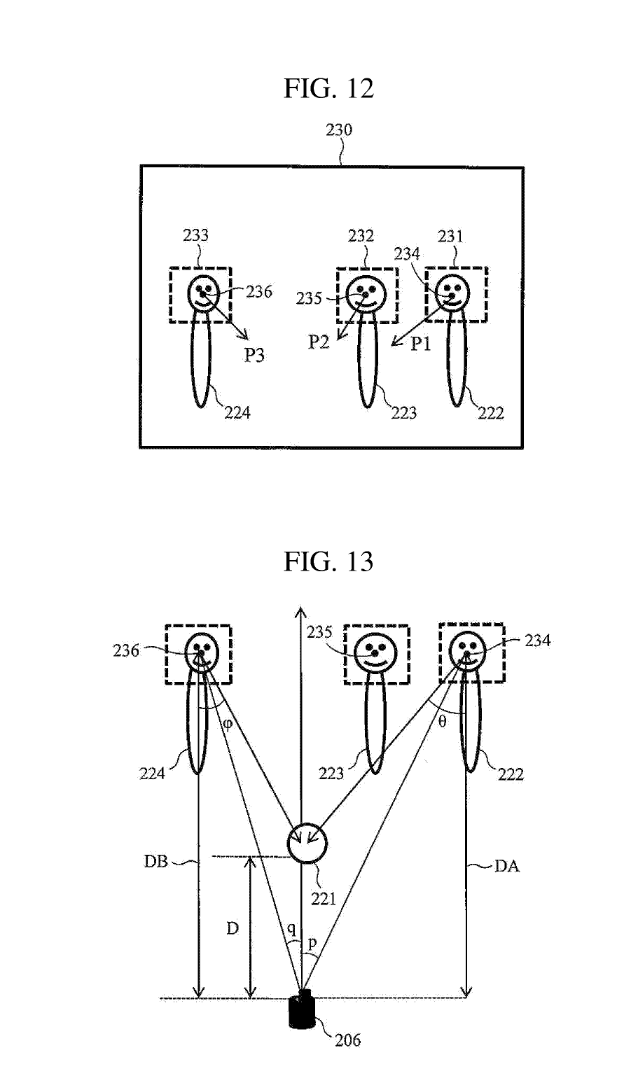

The six cameras from the first camera 201 to the sixth camera 206 are capturing images, and the captured images are transmitted via the LAN 208 to the image acquisition unit 210. The image acquisition unit 210 acquires the transmitted images (step S20), and temporarily keeps the images in memory. FIG. 12 illustrates a camera image 230 captured by the sixth camera 206 in the environment of FIG. 10. The images acquired by the image acquisition unit 210 are sent to a face detection unit 211. The face detection unit 211 performs a face detection process on the camera image 230 (step S21). Description of the face detection process will be omitted herein as it is performed by a method similar to that of the first embodiment. In FIG. 12, a first rectangular region 231, a second rectangular region 232, and a third rectangular region 233 which are indicated by broken lines respectively indicate the results of face detection performed on the faces of the second person 222, the third person 223, and the fourth person 224.

The present embodiment will be described with reference to the image captured by the sixth camera (FIG. 12) as the image for which face detection is performed on the basis of the assumed positional relationship of the persons. The face detection process is performed on the images from the first camera 201 to the fifth camera 205 similarly to the sixth camera 206, where the camera image for which face detection is performed varies in accordance with the positional relationship of the persons.

With respect to the first rectangular region 231, the second rectangular region 232, and the third rectangular region 233 which are the detected face regions, it is determined whether the feature point extraction unit 212 has performed a feature point extraction process to extract the positions of facial feature points, such as the positions of the nose, eyes, and mouth (step S22). The facial expression detection unit 213 determines a feature quantity from the plurality of feature points extracted by the feature point extraction unit 212, and detects whether the facial expression is a smiling face (step S23). Herein, of the plurality of faces detected in FIG. 12, the number of the faces detected as a smiling face is counted, and, if there are two such persons, for example, the process transitions to step S25; if less than two persons, the process returns to step S20 (step S24).

The face direction estimation unit 214, with respect to the faces detected as a smiling face by the facial expression detection unit 213, determines a feature quantity from the feature point extracted by the feature point extraction unit 212, and estimates the angle of the face direction with respect to the horizontal direction (step S25). Description of the facial expression detection and face direction estimation methods will be omitted as they concern the known technologies as in the case of the first embodiment.

The distance calculation unit 215, if the face directions of two or more persons have been estimated by the face direction estimation unit 214, estimates from the estimated face directions whether the two persons are paying attention to the same object (step S26). In the following, the method of estimating whether the attention is being placed on the same object will be described with respect to the case where the camera image 230 shown in FIG. 12 has been obtained.

Herein, the face direction includes a front direction of 0°, with the left direction as viewed from the camera being handled as being positive and the right direction as being negative, where the positive and negative directions each can be estimated up to a 60° range.

Whether the same object is being given the attention can be estimated by determining whether the face directions intersect between the persons on the basis of the positional relationship in which the persons' faces were detected and the respective face directions.

For example, with reference to the face direction of the person positioned at the right end in the image, if the angle of the face direction of the person adjacent to the left is small compared with the face direction of the person as a reference, it can be known that the face directions of the two persons intersect. While in the following description, the reference person is the person positioned at the right end in the image, the same can be said even when a person at another position is the reference, although the angular magnitude relationship may be varied. In this way, the intersection determination is made with respect to a combinations of a plurality of persons, thereby determining whether the attention is being placed on the same object.

A specific example will be described. The camera image 230 shows the faces of the second person 222, the third person 223, and the fourth person 224, arranged in the order of the second person 222, the third person 223, and the fourth person 224 from the right. If it is estimated that the face direction P1 is 30°, the face direction P2 is 10°, and the face direction P3 is −30°, in order for the face direction of the second person 222 and the face directions of the third person 223 and the fourth person 224 are to intersect with reference to the face direction of the second person 222, the respective face directions need to be smaller than 30°. Herein, because the face direction P2 of the third person 223 and the face direction P3 of the fourth person 224 are both smaller than 30°, i.e., 10° and −30°, respectively, the face directions of the three persons intersect, and it can be determined that they are watching the same object.

If the estimated face direction P1 is 40°, the face direction P2 is 20°, and the face direction P3 is 50°, if, with reference to the face direction of the second person 222, the face direction of the second person 222 and the face directions of the third person 223 and the fourth person 224 are to intersect, the respective face directions need to be less than 40°. However, the face direction P3 of the fourth person 224 is 50°, so that the face direction of the second person 222 and the face direction of the fourth person 224 do not intersect. Accordingly, it can be determined that the second person 222 and the third person 223 are watching the same object, and that the fourth person 224 is watching a different object.

In this case, in the next step S26, the face direction of the fourth person 224 is eliminated. If the estimated face direction P1 is 10°, the face direction P2 is 20°, and the face direction P3 is 30°, none of the face directions of the persons intersect. In this case, it is determined that the persons are paying attention to different objects, and the process returns to step S20 without transitioning to the next step S27.

If it is determined that the plurality of persons are watching the same object, the distance calculation unit 215 reads from the parameter information storage unit 217 an image-capturing resolution, camera information about angle of view, and the parameter information indicating corresponding relationship of face rectangle size and distance, and calculates the distance from each person to the object of attention by the principle of triangulation (step S27). Herein the face rectangle size refers to a pixel area of a lateral width by a longitudinal width in a rectangular region enclosing the face detected by the face detection unit 211. The parameter information indicating the face rectangle size and the distance corresponding relationship will be described later.

In the following, a distance calculation method will be described with reference to a specific example.

First, the distance calculation unit 215 reads from 217 the image-capturing resolution, the camera information about angle of view, the parameter information indicating corresponding relationship of face rectangle size and distance that are necessary for distance calculation. As illustrated in FIG. 12, from the first rectangular region 231, the second rectangular region 232, and the third rectangular region 233 respectively of the faces of the second person 222, the third person 223, and the fourth person 224 detected by the face detection unit 211, center coordinates 234, 235, and 236 respectively are calculated. For the distance calculation by the principle of triangulation, it is only necessary that the coordinates of at least two points be known. Thus, herein, the two points of the center coordinates 234 and the center coordinates 236 are used for the calculation.

Then, from the camera information such as the image-capturing resolution and the angle of view read from the parameter information storage unit 217, the angles from the camera to the center coordinates 234 and the center coordinates 236 respectively are calculated. For example, when the resolution is full-HD (1920×1080), the horizontal angle of view of the camera is 60°, the center coordinates 234 are (1620, 540), and the center coordinates 236 are (160, 540), the respective angles of the center coordinates as viewed from the camera are 21° and −25°. Thereafter, from the parameter information indicating corresponding relationship of face rectangle size and distance, the distances from the face rectangle 231 and the face rectangle 233 to the camera and each person are determined.

TABLE 2

| 237 | 238 |
|---|---|
| Rectangle size [pix] | Distance [m] |
| 30 × 30 [pix] | 5.40 |
| 40 × 40 [pix] | 4.50 |
| 50 × 50 [pix] | 3.50 |
| 60 × 60 [pix] | 3.00 |
| 70 × 70 [pix] | 2.50 |
| 80 × 80 [pix] | 2.00 |
| 90 × 90 [pix] | 1.50 |
| 100 × 100 [pix] | 1.10 |
| 110 × 110 [pix] | 0.90 |
| 120 × 120 [pix] | 0.80 |
| 130 × 130 [pix] | 0.70 |
| 140 × 140 [pix] | 0.60 |
| 150 × 150 [pix] | 0.55 |
| 160 × 160 [pix] | 0.52 |
| 170 × 170 [pix] | 0.50 |
| 180 × 180 [pix] | 0.48 |
| 190 × 190 [pix] | 0.47 |
| 200 × 200 [pix] | 0.46 |
| 210 × 210 [pix] | 0.45 |
| 220 × 220 [pix] | 0.44 |

Table 2 shows the parameter information indicating the corresponding relationship between face rectangle size and distance. The parameter information shows the corresponding relationship between the face rectangle size (pix) 237, which is the pixel area of the lateral width by longitudinal width of the facial rectangular region, and the corresponding distance (m) 238. The parameter information is calculated on the basis of the image-capturing resolution and the angle of view of the camera.

For example, when the face rectangle 231 has 80×80 pixels, the rectangle size 237 on the left side in Table 2 is referenced, and the corresponding distance is shown to be 2.0 m on the right side of Table 2. When the face rectangle 233 has 90×90 pixels, the corresponding distance is 1.5 m.

As illustrated in FIG. 13, when the distance from the sixth camera 206 to the first person 221 is D, the distance from the camera to the second person 222 is DA, the distance from the camera to the fourth person 224 is DB, the direction in which the second person 222 is watching the first person 221 is θ, the direction in which the fourth person 224 is watching the first person 221 is φ, the angle of the object 222 as viewed from the camera is p, and the angle of the object 224 as viewed from the camera is q, the following expression holds.

$$\begin{matrix}[ Expression 1 ] & \\ D = \frac{DA ( tan θ - tan p ) + DB ( tan ϕ - tan q )}{tan θ + tan ϕ} & ( 1 )\end{matrix}$$

From Expression (1), the distance from the camera to the first person 221 can be calculated.

When the face directions of the second person 222 and the fourth person 224 are respectively −30° and 30°, the distance from the camera to the first person 221 is 0.61 m.

The distance between the second person 222 and the object is the difference between the distance from the camera to the fourth person 224 and the distance from the camera to the object, and is 1.89 m. Similar calculations are performed for the third person 223 and the fourth person 224. Thus, the distance between each person and the object is calculated and the calculated results are sent to the stored camera image determination unit 216.

The stored camera image determination unit 216 determines two images as stored camera images. First, the camera image 230 captured by the sixth camera 206 in which smiling faces were detected is determined as a first stored image. Then, a second stored image is determined from the distance to the object of attention calculated by the distance calculation unit 215, the face direction of the detected persons, and the cameras that performed the face detection process, with reference to the parameter information stored in the parameter information storage unit 217, indicating the correspondence between the face direction and the image-capturing camera, created on the basis of the positional relationship of the six cameras from the first camera 201 to the sixth camera 206 used in the image-capturing system (step S28). In the following, a second stored image determination method will be described.

TABLE 3

| 240 | 241 | 242 |
|---|---|---|
| Face-detected | Image-capturing | Face |
| camera | camera candidate | direction |
| First camera | Fifth camera | 25~60 |
| | Fourth camera | −25~25 |
| | Third camera | −25~−60 |
| Second camera | Sixth camera | 25~60 |
| | Fifth camera | −25~25 |
| | Fourth camera | −25~−60 |
| Third camera | First camera | 25~60 |
| | Sixth camera | −25~25 |
| | Fifth camera | −25~−60 |
| Fourth camera | Sixth camera | 25~60 |
| | First camera | −25~25 |
| | Second camera | −25~−60 |
| Fifth camera | First camera | 25~60 |
| | Second camera | −25~25 |
| | Fourth camera | −25~−60 |
| Sixth camera | Second camera | 25~60 |
| | Third camera | −25~25 |
| | Fourth camera | −25~−60 |

The distance calculation unit 215 reads the distance from each of the second person 222, the third person 223, and the fourth person 224 to the first person 221 who is the object of attention, and refers to the parameter information stored in the parameter information storage unit 217 and shown in Table 3. The parameter information of Table 3 is created on the basis of the positional relationship of the six cameras from the first camera 201 to the sixth camera 206, where a face-detected camera item 240 and an image-capturing camera candidate item 241 of three cameras facing the face-detected camera are associated with each other. The face-detected camera item 240 is also associated with a face direction item 242 of the object of detection.

For example, when a face detection is performed with the image captured by the sixth camera 206 as in the environment of FIG. 10, any of the images captured by the opposite second camera 202, third camera 203, or fourth camera 204 is selected as the image-capturing camera candidate, as shown in Table 3. When the face directions of the second person 222, the third person 223, and the fourth person 224 detected by the respective cameras are 30°, 10°, and −30°, the cameras with matching face directions, i.e., the corresponding cameras are the fourth camera 204, the third camera 203, and the second camera 202 respectively from Table 3.

In this case, the distance from the second person 222 to the first person 221, the distance from the third person 223 to the first person 221, and the distance from the fourth person 224 to the first person 221 calculated by the distance calculation unit 215 are compared, and the camera image corresponding to the face direction of the person with the greatest distance from the object of attention is selected.

For example, when the distance from the second person 222 to the first person 221 is calculated to be 1.89 m, the distance from the third person 223 to the first person 221 to be 1.81 m, and the distance from the fourth person 224 to the first person 221 to be 1.41 m, it can be seen that the second person 222 is located at the farthest position. Because the camera corresponding to the face direction of the second person 222 is the second camera 202, finally the second camera image is determined as the second stored image of the stored camera images.

By thus selecting the camera image corresponding to the person located at the greatest distance, selection of an image in which the object of attention is blocked due to a small distance between the object of attention and a person watching the object can be avoided.

Further, when the face directions of a plurality of persons are toward a certain object of attention, by capturing a representative image instead of capturing individual images, unnecessarily captured images can be saved, whereby a decrease in data amount can be achieved.

In accordance with the result determined by the stored camera image determination unit 216, the determined two images of the six images captured by the first camera 201, the second camera 202, the third camera 203, the fourth camera 204, the fifth camera 205, and the sixth camera 206 that have been temporarily retained in memory in the stored image acquisition unit 210 are transferred to the image storage unit 217 and stored therein (step S29).

With regard to step S24, the process is herein set to proceed to the next step only when two or more persons of which the facial expression was detected to be a smile are found. However, the number of the persons is not necessarily limited to two and may be more than two.

In step S27, the distance calculation unit 215 calculates the distances on the basis of the image-capturing resolution, the camera information about angle of view, and the parameter information indicating the corresponding relationship of face rectangle size and distance from the parameter information storage unit 217. However, it is not necessarily required to calculate the distance strictly for each person, and the stored camera image may be determined on the basis of an approximate distance relationship which can be known from the rectangle size at the time of face detection.

The present embodiment has been described with reference to the case where the distance to the object of attention is calculated from the face direction of two or more persons. However, even when there is only one person, an approximate distance to the object of attention can be determined by estimating the face direction in the vertical direction. For example, when a face direction parallel with the ground is defined as the face direction with the vertical direction of 0°, as the distance from the face to the object of attention is increased, the face angle becomes smaller when the object of attention is farther compared with when the object of attention is closer. This may be utilized to determine the stored camera image.

While the present embodiment has been described with reference to the example using six cameras, this is merely an example and the number of the cameras used may be varied depending on the environment of use.

Further, the present embodiment has been described with reference to the case where the six cameras of the first camera, the second camera, the third camera, the fourth camera, the fifth camera, and the sixth camera are used, and face detection is performed with respect to the picture captured by the sixth camera. However, when face detection is performed using a plurality of camera images, the same person may be inadvertently detected. In that case, at the time of acquiring the feature points, a recognition process may be performed to determine if there is a face having a similar feature quantity by another camera. In this way, it can be determined whether the same person has been detected by the other camera, whereby, at the time of estimating the face direction, the face direction results of the face of the same person can be compared to adopt the camera image of which the face direction is closer to the front 0° as the first stored image.

In this way, taking a picture of one person multiple times can be avoided, whereby unnecessarily captured images can be saved.

### Third Embodiment

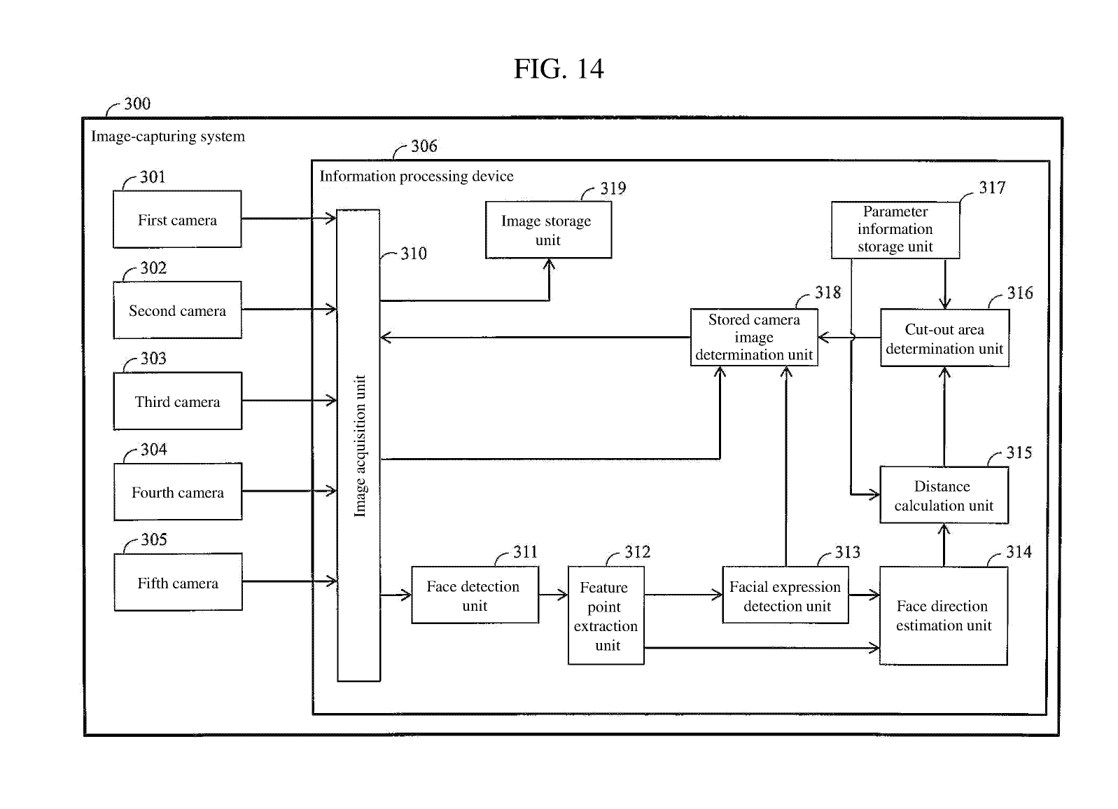

In the following, a third embodiment of the present invention will be described with reference to the drawings. FIG. 14 is a block diagram of a configuration of the image-capturing system according to the third embodiment of the present invention.

An image-capturing system 300 includes a total of five cameras including a first camera 301, a second camera 302, a third camera 303, a fourth camera 304, and a fifth camera 305 having a wider angle of view than those of the four cameras from the first camera 301 to the fourth camera 304, and an information processing device 306.

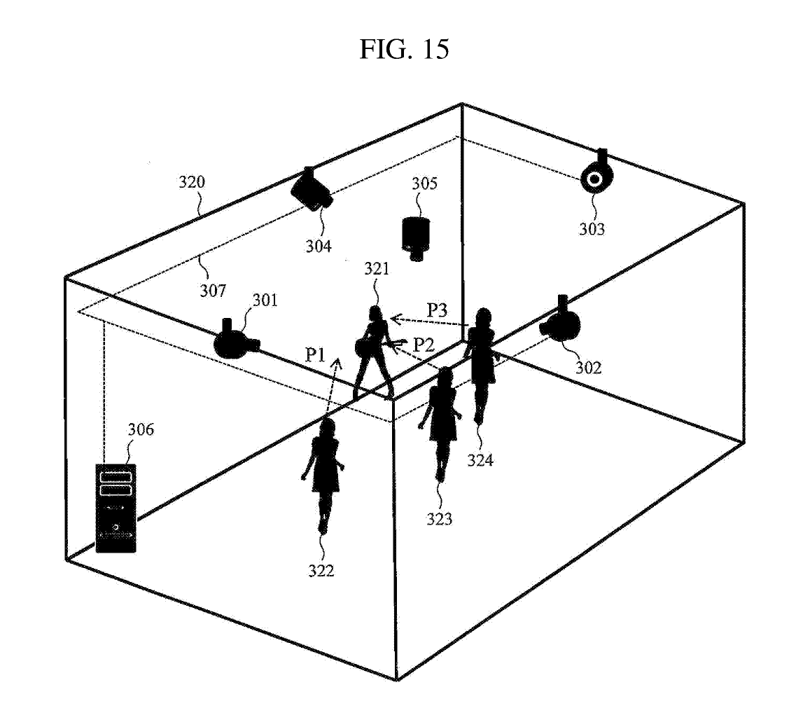

The information processing device 306 includes an image acquisition unit 310 that acquires images captured by the five cameras from the first camera 301 to the fifth camera 305; a face detection unit 311 that detects a human face from those of the images acquired by the image acquisition unit 310 that have been captured by the cameras other than the fifth camera 305; a feature point extraction unit 312 that extracts a plurality of feature points from the face detected by the face detection unit 311; a facial expression detection unit 313 that detects feature quantities from the positions of the plurality of feature points extracted by the feature point extraction unit 312 to detect a facial expression; a face direction estimation unit 314 that, with respect to the face of which the facial expression is detected by the facial expression detection unit 313, determines feature quantity from the positions of the plurality of feature points extracted by the feature point extraction unit 312 to estimate a face direction; a distance calculation unit 315 that calculates distances from the plurality of persons to an object from the face directions of the persons estimated by the face direction estimation unit 314; a cut-out area determination unit 316 that determines a cut-out area of the image of the fifth camera 305 by referring to the distance calculated by the distance calculation unit 315, the face direction estimated by the face direction estimation unit 314, and the parameter information, stored in the parameter information storage unit 317, that is created on the basis of the positional relationship of the five cameras from the first camera 301 to the fifth camera 305 and indicating correspondence with the cut-out area of the fifth camera 305 image; a stored camera image determination unit 318 that determines, as the stored camera images, two images of the camera image detected by the facial expression detection unit 313 and an image that is cut out from the fifth camera image in accordance with the cut-out area determined by the cut-out area determination unit 316; and an image storage unit 319 that stores the images determined by the stored camera image determination unit 318. An example of the environment of use for the image-capturing system according to the present embodiment is illustrated in FIG. 15.

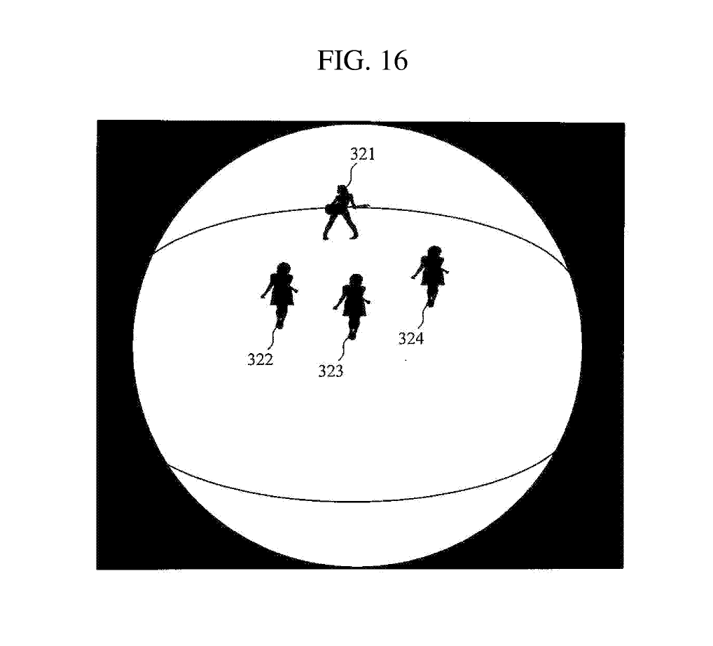

In FIG. 15, the image-capturing system 300 of FIG. 14 is installed in a room 320, where the information processing device 306 is connected to the first camera 301, the second camera 302, the third camera 303, the fourth camera 304, and the fifth camera 305, which are installed on the roof, via a LAN 307, for example, as in the first and the second embodiments. The cameras other than the fifth camera 305 are inclined downwardly with respect to the roof of the room 320, while the fifth camera 305 is installed facing downward at the center of the roof of the room 320. The fifth camera 305 has a wide angle of view compared with the cameras from the first camera 301 to the fourth camera 304. For example, the image captured by the fifth camera 305 shows approximately the entire room 320, as illustrated in FIG. 16. The first camera 301 to the fourth camera 304 have an angle of view of 60°, for example. The fifth camera 305 is, e.g., a fish-eye camera of an equidistant projection system such that the distance from the center of a circle with an angle of view of 170° is proportional to the incident angle.

In the room 320, there are a first person 321, a second person 322, a third person 323, and a fourth person 324, as in the second embodiment. The first person 321 is drawing attention from the second person 322, the third person 323, and the fourth person 324 respectively in the face direction P1, the face direction P2, and the face direction P3. The following description will be made with reference to such an assumed situation.

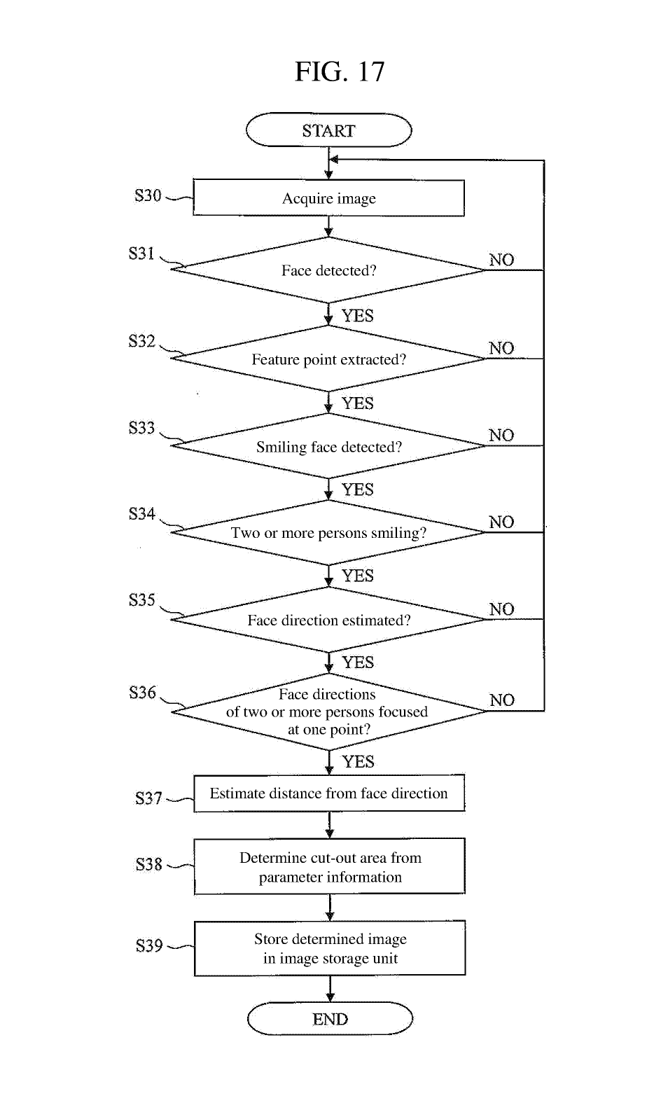

FIG. 17 is a flowchart of the flow of a process in the image-capturing system according to the present embodiment. The details of the functions of the various units will be described with reference to the flowchart.

The five cameras from the first camera 301 to the fifth camera 305 are taking pictures, and the captured images are transmitted to the image acquisition unit 310 via the LAN 307, as in second embodiment. The image acquisition unit 310 acquires the transmitted images (step S30), and temporarily keeps the images in memory. The images acquired by the image acquisition unit 310 other than the fifth camera image are sent to the face detection unit 311. The face detection unit 311 performs a face detection process on all of the images transmitted from the image acquisition unit 310 (step S31). In the environment of use according to the present embodiment, the faces of the second person 322, the third person 323, and the fourth person 324 are captured by the fourth camera 304. Thus, in the following, a case will be described in which the face detection process is performed on the image of the fourth camera 304.

In step S32, based on the result of the face detection process performed with respect to the faces of the second person 322, the third person 323, and the fourth person 324, it is determined whether the positions of the facial feature points, such as the nose, eyes, and the mouth, have been extracted by the feature point extraction unit 312 through the feature point extraction process (step S32). The facial expression detection unit 313 determines feature quantities from the positions of a plurality of feature points extracted by the feature point extraction unit 312, and detects whether the facial expression is a smiling face (step S33). Herein, among a plurality of the detected faces, the number of the faces of which the facial expression is estimated to be a smiling face, for example, is counted (step S34). If there are two or more such persons, the process transitions to step S35; if the number is less than two, the process returns to step S30. The face direction estimation unit 314, with respect to the faces estimated to be smiling faces by the facial expression detection unit 313, determines feature quantities from the positions of the feature points extracted by the feature point extraction unit 312, and estimates the angle at which the face direction is inclined with respect to the horizontal direction (step S35). If the face directions of two or more persons are estimated by the face direction estimation unit 314, the distance calculation unit 315 estimates from the respective estimated face directions whether the two persons are paying attention to the same object (step S36). If it is determined that a plurality of persons (herein two or more persons) are watching the same object, the distance calculation unit 315 reads the image-capturing resolution, the camera information about angle of view, and the parameter information indicating the corresponding relationship of face rectangle size and distance from the parameter information storage unit 317, and calculates the distance to the object by the principle of triangulation (step S37).

Herein the face rectangle size refers to a pixel area of a lateral width by a longitudinal width in a rectangular region enclosing the face detected by the face detection unit 311. Detailed description of the process from step S31 to step S37 will be omitted as the process is similar to the one described with reference to the second embodiment. The cut-out area determination unit 316 determines a cut-out area of the image captured by the fifth camera 305 from the distance from the camera to the object of attention calculated by the distance calculation unit 315 and the face direction of the detected person, with reference to parameter information stored in the parameter information storage unit 317 that is created on the basis of the positional relationship of the five cameras from the first camera 301 to the fifth camera 305 used in the image-capturing system, the parameter information indicating the corresponding relationship of the position of person and the distance (step S38). In the following, a method for determining the cut-out area of the image captured by the fifth camera 305 will be described in detail.

TABLE 4

| | | Corre- | Corre- | | | Corre- | Corre- | | | | |
|---|---|---|---|---|---|---|---|---|---|---|---|
| | | sponding | sponding | Dis- | | sponding | sponding | | | Corresponding | Corresponding |
| Distance | Angle | point x | point y | tance | Angle | point x | point y | Distance | Angle | point x | point y |
| [m] | [degrees] | coordinate | coordinate | [m] | [degrees] | coordinate | coordinate | [m] | [degrees] | coordinate | coordinate |
| 3.50 | 21 | 1740 | 503 | 3.50 | 55 | 138 | 423 | 3.50 | 20 | 1703 | 90 |
| 3.00 | 21 | 1703 | 480 | 3.00 | 55 | 182 | 400 | 3.00 | 20 | 1666 | 113 |
| 2.50 | 21 | 1666 | 457 | 2.50 | 55 | 226 | 377 | 2.50 | 20 | 1629 | 136 |
| 2.00 | 21 | 1629 | 434 | 2.00 | 55 | 270 | 354 | 2.00 | 20 | 1592 | 159 |
| 1.50 | 21 | 1592 | 411 | 1.50 | 55 | 314 | 331 | 1.50 | 20 | 1555 | 182 |
| 1.10 | 21 | 1555 | 388 | 1.10 | 55 | 358 | 308 | 1.10 | 20 | 1518 | 205 |
| 0.90 | 21 | 1518 | 365 | 0.90 | 55 | 402 | 285 | 0.90 | 20 | 1481 | 228 |
| 0.80 | 21 | 1481 | 342 | 0.80 | 55 | 446 | 262 | 0.80 | 20 | 1444 | 251 |
| 0.70 | 21 | 1444 | 319 | 0.70 | 55 | 490 | 240 | 0.70 | 20 | 1407 | 274 |
| 0.61 | 21 | 1407 | 297 | 0.61 | 55 | 534 | 217 | 0.61 | 20 | 1370 | 296 |
| 0.55 | 21 | 1370 | 274 | 0.55 | 55 | 578 | 194 | 0.55 | 20 | 1333 | 319 |
| 0.52 | 21 | 1333 | 251 | 0.52 | 55 | 622 | 171 | 0.52 | 20 | 1296 | 342 |
| 0.50 | 21 | 1296 | 228 | 0.50 | 55 | 666 | 148 | 0.50 | 20 | 1259 | 365 |
| 0.48 | 21 | 1259 | 205 | 0.48 | 55 | 710 | 125 | 0.48 | 20 | 1222 | 388 |
| 0.47 | 21 | 1222 | 182 | 0.47 | 55 | 754 | 102 | 0.47 | 20 | 1185 | 411 |
| 0.46 | 21 | 1185 | 159 | 0.46 | 55 | 798 | 79 | 0.46 | 20 | 1148 | 434 |
| 0.45 | 21 | 1148 | 136 | 0.45 | 55 | 842 | 56 | 0.45 | 20 | 1111 | 457 |
| 0.44 | 21 | 1111 | 113 | 0.44 | 55 | 886 | 33 | 0.44 | 20 | 1074 | 480 |

When the distances calculated by the distance calculation unit 315 from the fourth camera 304 to the person 324, the person 323, the person 322, and the person 321 as the object of attention are respectively 2.5 m, 2.3 m, 2.0 m, and 0.61 m, the angles of the persons and the person as the object of attention as viewed from the fourth camera 304 are respectively −21°, 15°, 25°, and 20°, and the resolution of the fifth camera is full-HD (1920×1080), the correspondence table shown in Table 4 is referenced from the parameter information storage unit 317. Table 4 is a part of the correspondence table. In the parameter storage unit 317, the correspondence table is prepared for each of the cameras from the first camera 301 to the fourth camera 304, and the corresponding coordinates of the fifth camera 305 can be determined from all of the combinations of angle and distance. From the correspondence table, when the corresponding coordinates 332 of the fifth camera 305 are determined from the distance 330 from the fourth camera 304 to a person and the angle 331 of the person as viewed from the fourth camera 304, if the angle of the person 324 as viewed from the fourth camera 304 is −21° and the distance is 2.5 m, the corresponding point for the fifth camera 305 is at the coordinates (1666, 457); if the angle to the person 322 as viewed from the fourth camera 304 is 25° and the distance is 2.0 m, the coordinates are (270, 354). Similarly, the corresponding coordinates of the person 321 as the object of attention are the coordinates (824, 296) according to the correspondence table. This correspondence table is determined from the camera arrangement of the cameras from the first camera 301 to the fourth camera 304 and the fifth camera 305.

From the coordinates of the three points determined above, a rectangle enclosed from the coordinates (270, 296) to the coordinates (1666, 457) is enlarged vertically and horizontally by 50 pixels, producing a rectangle enclosed from the coordinates (320, 346) to the coordinates (1710, 507), which is determined as the cut-out area for the image of the fifth camera 305.

The stored camera image determination unit 318 determines two images as the stored camera images. First, the camera image captured by the fourth camera 304 in which a smiling face was detected is determined as a first stored image. Then, an image obtained by cutting out the cut-out area determined by the cut-out area determination unit 316 from the camera image captured by the fifth camera 305 is determined as a second stored image (step S38). In accordance with the determined results, of the five images temporarily retained in memory in the image acquisition unit 310 that have been captured by the first camera 301, the second camera 302, the third camera 303, the fourth camera 304, and the fifth camera 305, the two of the camera image of the fourth camera 304 and the camera image (after cutting-out) of the fifth camera 305 that have been determined are transferred to the image storage unit 319 and stored therein (step S39).

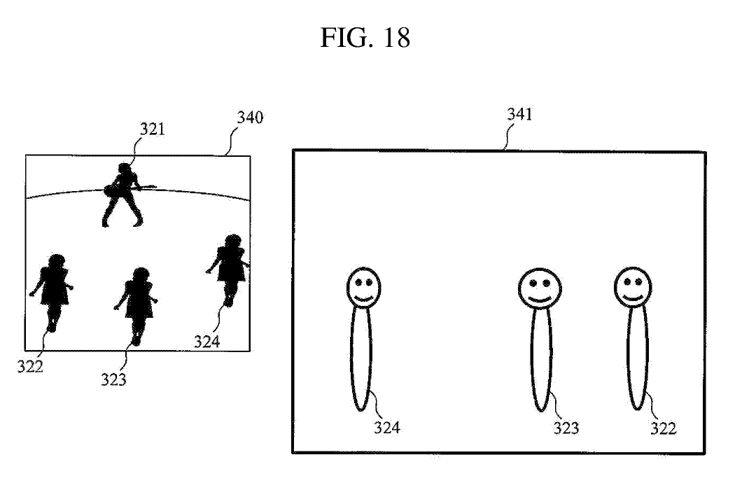

In the present embodiment, the two images 340 and 341 that are stored (the first stored image and the second stored image) are illustrated in FIG. 18. A front image of the second to the fourth persons 322-324 is the first stored image. The second stored image shows a front image of the first person 321 and a back image of the second to the fourth persons 322-324.

As described above, the cut-out area is determined from the fish-eye camera image in view of the positions of the persons watching the same object of attention and the position of the object of attention, an image including both the persons watching the object of attention and the object of attention can be captured.

In step S38, the cut-out area that is finally determined is based on a 50-pixels enlargement both vertically and horizontally. However, the number of the pixels for the enlargement is not necessarily required to be 50 pixels and may be freely set by the user of the image-capturing system 300 according to the present embodiment.

### Fourth Embodiment

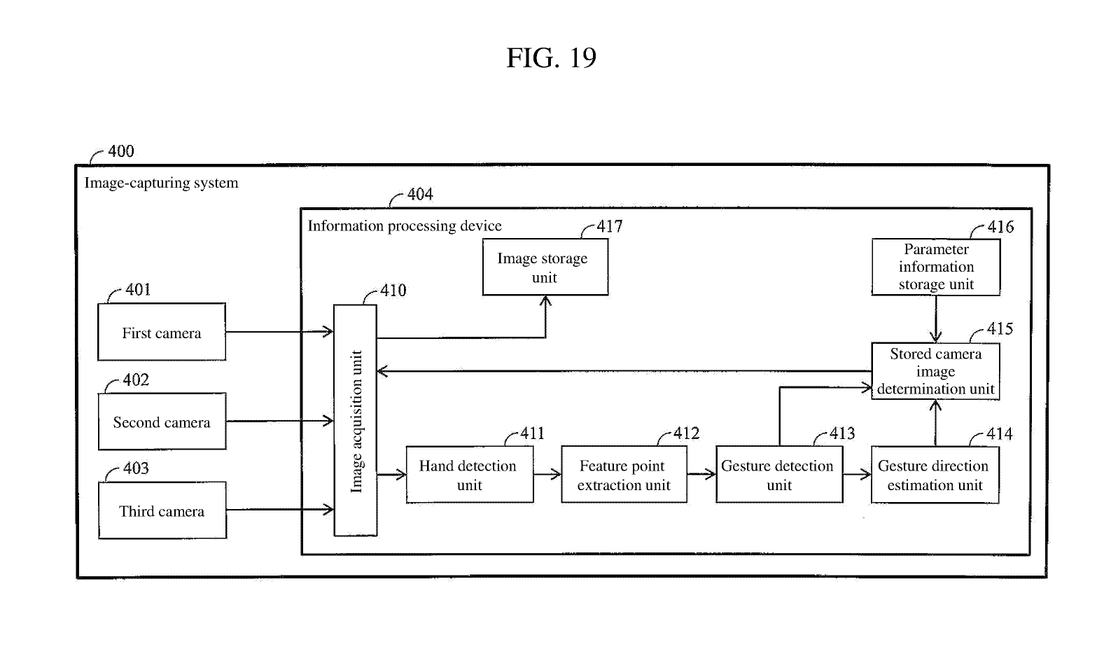

In the following, a fourth embodiment of the present invention will be described with reference to the drawings. FIG. 19 is a block diagram of a configuration of the image-capturing system according to the fourth embodiment of the present invention.

In the foregoing embodiments, the first stored image is determined at the timing of a change in the facial expression of the subject person, and the second stored image is determined by identifying the camera in accordance with the direction in which the subject person is facing. The timing may be based on a change in the position or direction of the body (such as hands or legs) or the face that can be detected from an image captured by the cameras, instead of a change in the subject's facial expression. Also, instead of the direction in which the subject as a whole is facing, the direction of the face may be determined and a distance may be identified on the basis of the direction of the face so as to control the selection of a camera or the image-capturing direction of the camera. The change in feature quantity to be detected may also include a change in environment, such as the ambient brightness.

In the following, an example will be described in which a change in a gesture movement by a person's hand is used as an example of the change in feature quantity, and in which the direction in which the gesture is oriented is estimated.

An image-capturing system 400 includes three cameras of a first camera 401, a second camera 402, and a third camera 403 and an information processing device 404. The information processing device 404 includes an image acquisition unit 410 that acquires the images captured by the first camera 401, the second camera 402, and the third camera 403; a hand detection unit 411 that detects a person's hand from the images acquired by the image acquisition unit 410; a feature point extraction unit 412 that extracts a plurality of feature points from the hand detected by the hand detection unit 411; a gesture detection unit 413 that detects a hand gesture from feature quantities determined from the plurality of feature points extracted by the feature point extraction unit 412; a gesture direction estimation unit 414 that, with respect to the hand of which the gesture has been detected by the gesture detection unit 413, estimates the direction in which the gesture is oriented from the feature quantities determined from the plurality of feature points extracted by the feature point extraction unit 412; a parameter information storage unit 416 in which parameter information indicating the positional relationship of the first camera 401, the second camera 402, and the third camera 403 is stored; a stored camera image determination unit 415 that determines an image selected in accordance with the image of which the gesture has been detected by the gesture detection unit 413 and the gesture direction estimated by the gesture direction estimation unit 414 and with reference to the parameter information recorded in the parameter information storage unit 416 as a stored camera image; and an image storage unit 417 that stores the image determined by the stored camera image determination unit 415.

According to the present embodiment, the gesture detection unit 413 and the gesture direction estimation unit 414 each include a feature quantity calculation unit for calculating feature quantities from the plurality of feature points extracted by the feature point extraction unit 412 (as in FIG. 1).

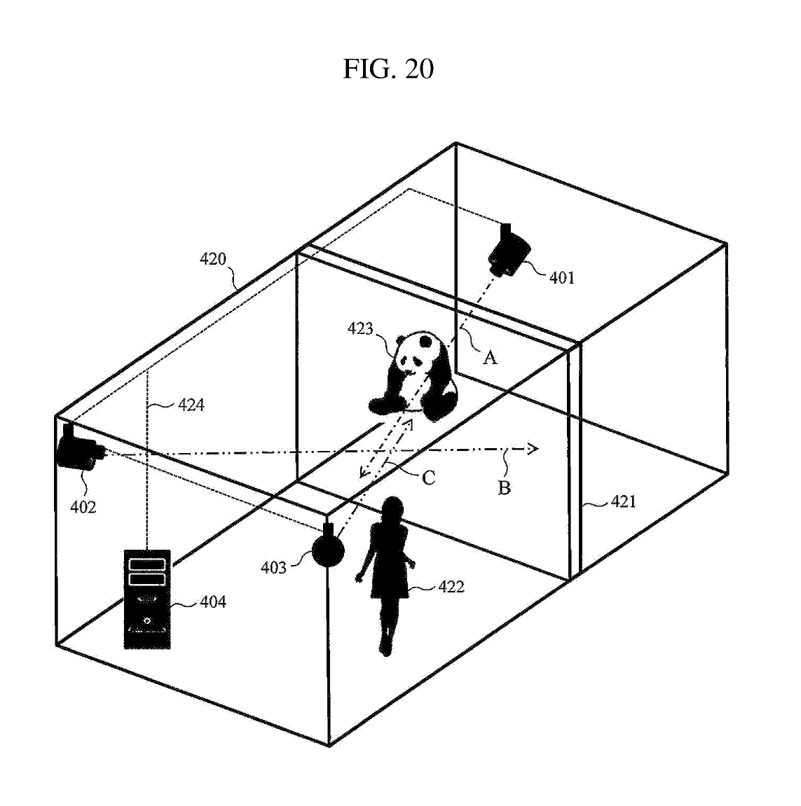

An example of the environment of use for the present image-capturing system will be described with reference to an environment illustrated in FIG. 20, which is similar to the environment of the first embodiment. In FIG. 20, the image-capturing system is installed in a room 420, where an information processing device 404 is connected to the first camera 401, the second camera 402, and the third camera 403, which are installed on the roof, via a LAN 424 (Local Area Network). In the room 420, there are a person 422 and an object 423, which is an animal, with a glass board 421 installed between the person 422 and the object 423. The glass board 421 is transparent so that the person 422 and the object 423 can see each other. The first camera 401 captures an image in a direction A in which the person 422 is present across the glass board 421. The second camera and the third camera capture images respectively in a direction B and a direction C in which the object 423 is present.

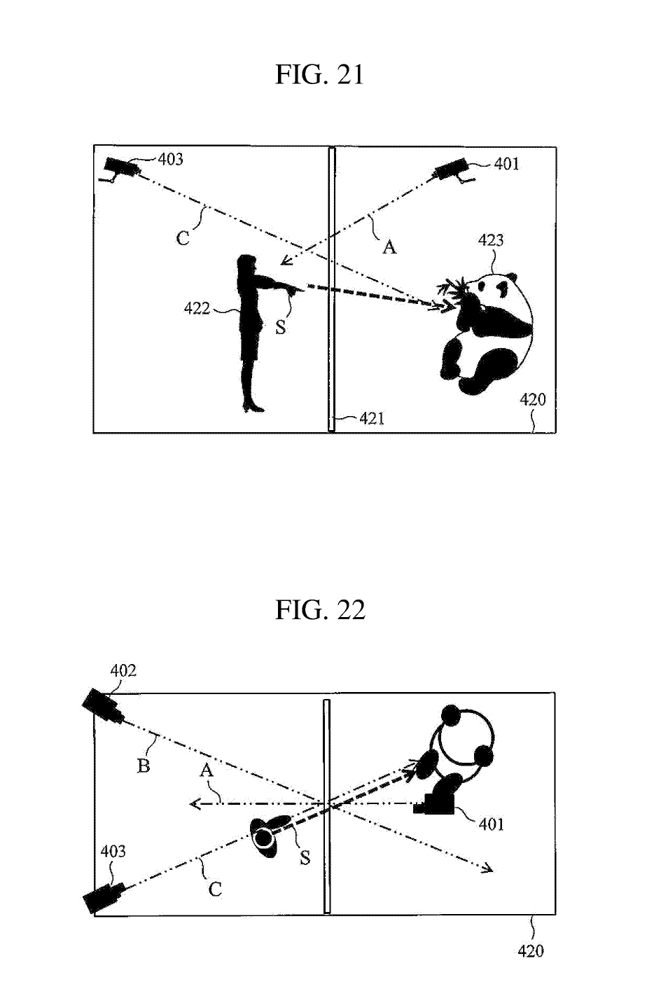

FIG. 21 is a lateral view of the room 420, and FIG. 22 is a bird's-eye view of the room 420. The first camera 401, the second camera 402, and the third camera 403 are installed so as to capture images in downwardly inclined directions with respect to the roof of the room 420. The second camera 402 is installed at approximately the same height as the third camera 403, so that the second camera 402 is hidden behind the third camera 403 in FIG. 21. The first camera 401 captures an image in direction A where the person 422 is present as mentioned above. Similarly, the second camera 402 and the third camera 403 capture images respectively in direction B and direction C where the object 423 is present. The first camera 401 is installed approximately parallel to the long sides of the walls of the room 420. The second camera 402 and the third camera 403 are installed facing mutually inward so that the optical axes in direction B and direction C intersect at a position along the long sides.

Herein, a situation is assumed in which the person 422 is pointing a finger in direction S at the object 423 across the glass board 421.

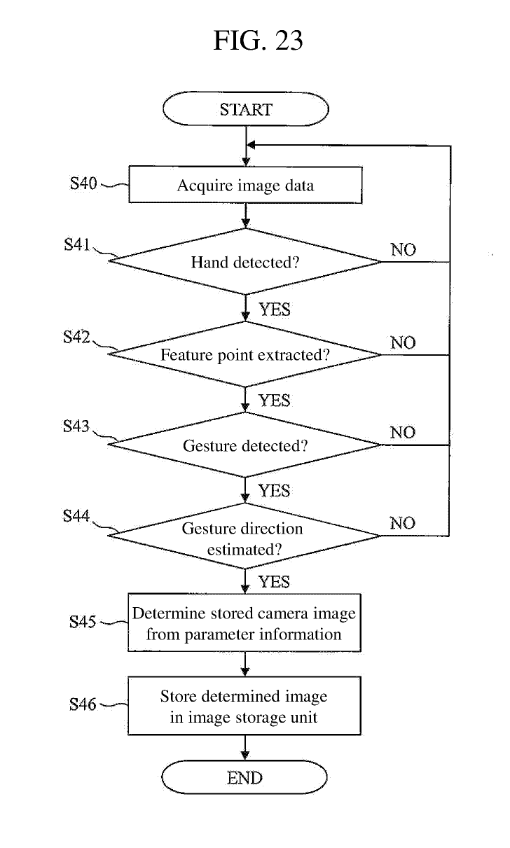

FIG. 23 is a flowchart of the flow of a process in the present image-capturing system. The details of the functions of the various units will be described with reference to the flowchart.

The first camera 401, the second camera 402, and the third camera 403 are capturing images, and the captured images are transmitted via the LAN 424 to the image acquisition unit 410. The image acquisition unit 410 acquires the transmitted images (step S40) and temporarily keeps the images in memory.

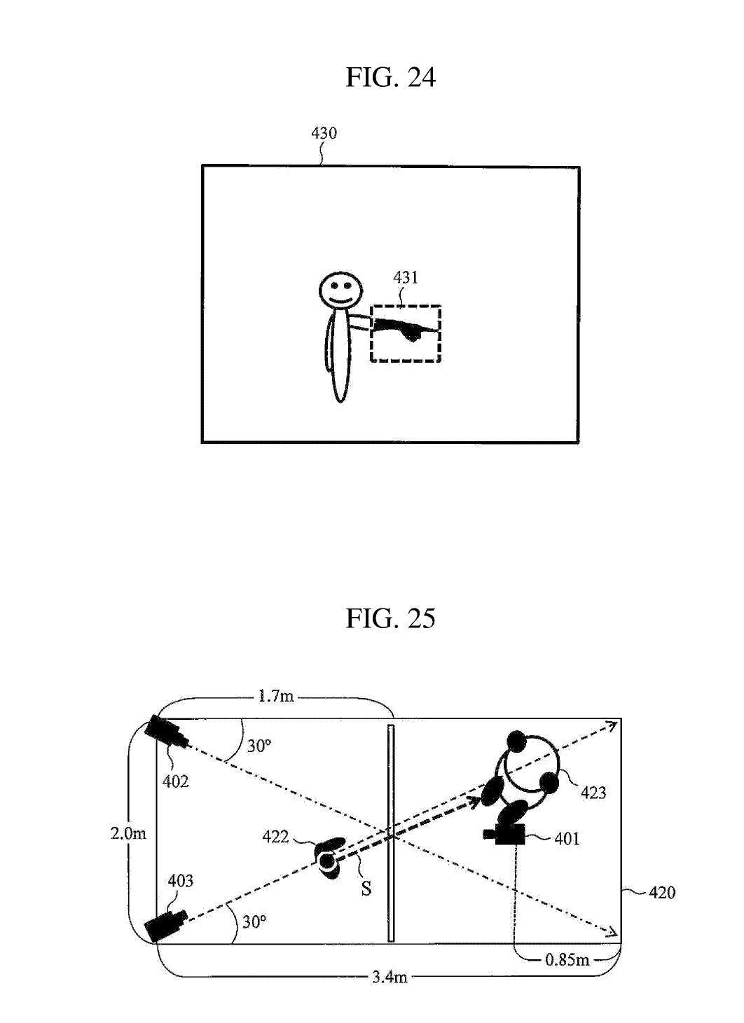

FIG. 24 illustrates an example of a camera image 430 captured by the first camera 401 in the environment of FIG. 20. The images acquired by the image acquisition unit 410 are sent to the hand detection unit 411. The hand detection unit 411 performs a hand detection process on the camera image 430 (step S41). The hand detection process includes extracting only a skin-colored region indicating the typical color of the human skin from the image for hand detection, and ascertaining whether there is an edge along the contour of a finger.

According to the present embodiment, the image for hand detection is the image captured by the first camera, and the images from the second camera and the third camera are not subjected to the hand detection process. A detected result of the hand detection process is shown in a rectangular region 431 indicated by broken lines in FIG. 24. With respect to the rectangular region 431, i.e., the detected hand region, the feature point extraction unit 412 determines whether a feature point has been extracted by a feature point extraction process that extracts the position of a feature point of the hand, such as the fingertip or a gap between fingers (step S42).

The gesture detection unit 413 determines, from a plurality of feature points extracted by the feature point extraction unit 412, a distance between feature points, the area enclosed by three feature points, and a feature quantity of brightness distribution, and detects a gesture by referring to a database in which the feature quantities as a result of feature point extraction corresponding to the gestures acquired from the hands of a plurality of persons in advance are gathered (step S43). Herein, the gesture detected by the gesture detection unit 413 is the pointing of a finger (the gesture where only the index finger is raised and pointed toward the object of attention). However, according to the present invention, the gesture may refer to any of the characteristic hand shapes, such as an open hand (with the five fingers separated and extended), a first (with all of the five fingers tightened), as well as the pointing of a finger, and the gesture detection unit 413 detects any of such gestures. What gesture is to be set may be freely decided on by the user of the present image-capturing system 400.

If the gesture detected in FIG. 24 is a particular gesture such as a finger pointing, the process transitions to step S44; if the particular gesture such as finger pointing is not detected, the process returns to step S40.

By capturing an image only when there is the particular gesture, the total volume of the captured images can be reduced.

The gesture direction estimation unit 414 then estimates, from the feature quantity determined from the position of the feature point extracted by the feature point extraction unit 412, the angle of orientation of the detected gesture with respect to the right and left direction (step S44). Herein, the gesture direction refers to the direction in which the gesture detected by the gesture detection unit is oriented. For example, the gesture direction is the direction pointed by the finger in the case of the finger pointing, or the direction in which the arm is oriented in the case of an opened hand or a fist.

The feature quantity may be similar to that described with reference to the gesture detection unit 413. For the gesture direction estimation, the direction in which the detected gesture is oriented is estimated by referring to the database in which the feature quantities of hand shapes and the like acquired from the hands of a plurality of persons in advance as a result of feature point extraction are gathered. Alternatively, the face may be detected in advance, and the direction in which a gesture is oriented may be estimated on the basis of a positional relationship with the detected hand.

Herein, it is assumed that the estimated angle can be estimated in an angle range of 60° for each of the left, i.e., negative, angle and the right, i.e., positive angle with respect to the right-left direction angle of 0° of the front as viewed from the camera. Further description of the hand detection method, the gesture detection method, and the gesture direction estimation method will be omitted as they involve known technologies.

The stored camera image determination unit 415 determines, as the stored camera images, two camera images that are determined from the camera image detected by the gesture detection unit 413 and the gesture direction estimated by the gesture direction estimation unit 414 and with reference to parameter information indicating the correspondence of the gesture direction and the image-capturing camera created on the basis of the positional relationship of the second camera and the third camera and stored in the parameter information storage unit 416 (step S45). Hereafter, the camera image detected by the gesture detection unit 413 will be referred to as the first stored image, and the camera image determined with reference to the parameter information will be referred to as the second stored image.

In the following, the parameter information and the stored camera image determination method will be described with reference to a specific example.

TABLE 5

| 440 | 441 |
|---|---|
| Gesture direction | Stored image- |
| (angle) | capturing camera |
| −60 | Second camera |
| −50 | Second camera |
| −40 | Second camera |
| −30 | Second camera |
| −20 | Second camera |
| −10 | Second camera |
| 0 | Third camera |
| 10 | Third camera |
| 20 | Third camera |
| 30 | Third camera |
| 40 | Third camera |
| 50 | Third camera |
| 60 | Third camera |

The parameter information shows, as illustrated in Table 5, the corresponding relationship of the stored-image capturing camera corresponding to the gesture direction. The parameter information is determined on the basis of the size of the room and the positions of the first camera 401, the second camera 402, and the third camera 403. In the present example, the parameter information is created from the camera arrangement, as in the case of the first embodiment. As illustrated in FIG. 25, the room 420 is a room measuring 2.0 m longitudinally by 3.4 m laterally, where the first camera 401 is positioned 0.85 m from the right end and installed to be approximately parallel with the long sides of the walls. The second camera 402 and the third camera 403 are respectively installed facing inward at 30° with respect to the long sides of the walls. When the direction in which the person 422 made a gesture facing directly opposite the direction in which the first camera 401 is capturing an image is 0°, the angle formed by a gesture direction S of the person 422 and the direction in which the second camera 402 is oriented, and the angle formed by the gesture direction S and the direction in which the third camera 403 is oriented are compared, and the corresponding relationship is determined such that the camera image minimizing the angle difference provides the stored camera image. In this way, the parameter information is created.

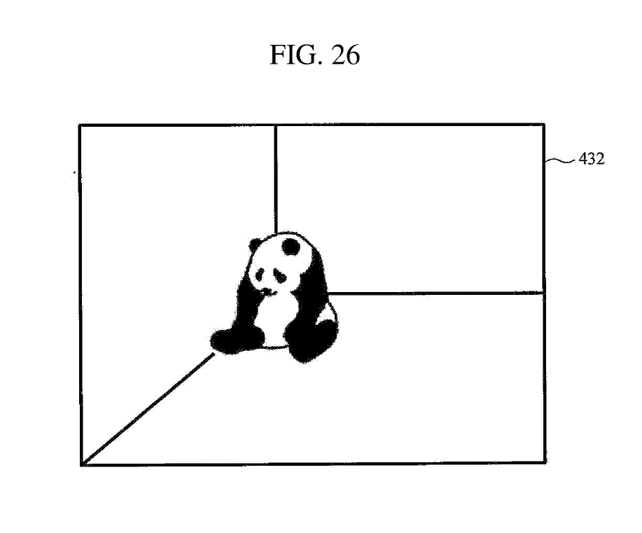

With regard to the stored camera image determination method, if, in the gesture image captured by the first camera 401, the gesture direction estimated by the gesture direction estimation unit 414 is 30°, the third camera 403 is determined as the stored camera image with reference to the parameter information shown in Table 5. FIG. 26 illustrates a stored camera image 432 determined in this case. If, in the gesture image captured by the first camera 401, the gesture direction estimated by the gesture direction estimation unit 414 is −60°, the second camera 402 is determined as a stored camera, similarly with reference to Table 5. Herein, if the gesture direction (angle) is not described in Table 5, the closest one of the described gesture directions is selected.

In accordance with the result determined in step S45, the two images that have been determined from among the three images captured by the first camera 401, the second camera 402, and the third camera 403 and temporarily retained in memory in the image acquisition unit 410 are transferred to the image storage unit 417 and stored therein (step S46).

Specifically, herein, the camera image 430 captured by the first camera 401 provides the first stored image, and the camera image 432 captured by the third camera 403 and showing the object pointed by the gesture provides the second stored image. Thus, the direction of a gesture is identified and the image captured by the camera showing the direction being pointed by the person is selected as a stored camera image, together with the image at the point in time when the particular gesture was made by the person. In this way, when the images are later confirmed, it can be known what it is that the person was pointing his or her finger to, whereby the situation or event at the point in time of image capturing can be recognized with greater details.

According to the present embodiment, together with the image at the point in time of a gesture made by the subject person, the image captured by the camera capturing an image in the direction indicated by the gesture made by the person is recorded. Accordingly, when the images are later confirmed, it can be known what it was that the person pointed his or her finger to, whereby the situation or event at the point in time of image capturing can be recognized with greater details.

In the example according to the present embodiment, the case has been described in which the process transitions to step S44 only when the gesture was a finger pointing in step S43. However, the transition may occur not only when the gesture is a finger pointing but also when other gestures are made.

It should be noted that the embodiments are not to be taken to interpret the present invention in a limited sense, that various modifications may be made within the scope of the matters set forth in the claims, and that such modifications are included in the technical scope of the present invention.

The constituent elements of the present invention may be adopted or discarded or otherwise selected as needed, and inventions provided with the thus selected configurations are also included in the present invention.

A program for implementing the functions described with reference to the embodiments may be recorded in a computer-readable recording medium, and the program recorded in the recording medium may be read by a computer system and executed to perform the processes of the various units. The “computer system” herein includes an OS, peripheral devices, and other hardware.

The “computer system”, when utilizing a WWW system, may include a web-page providing environment (or display environment).

A “computer-readable recording medium” refers to a portable medium, such as a flexible disc, a magneto-optic disk, a ROM, or a CD-ROM, and a storage device such as a hard disk contained in a computer system. The “computer-readable recording medium” may also include media that retain a program dynamically for a short time, such as a communications line in the case of transmission of the program via a network such as the Internet or a communications line such as a telephone line, and media that retain the program for a certain time, such as a volatile memory in a computer system serving as a server or a client in the case of such transmission. The program may be adapted to implement some of the described functions, or to implement the described functions in combination with the program already recorded in the computer system. At least some of the functions may be implemented by hardware such as an integrated circuit.

### (Notes)

The present invention includes the following disclosures.

(1)

An image-capturing system including at least three cameras with different image-capturing directions, a feature point extraction unit that extracts a feature point of a subject from images captured by the cameras, and an image storage unit that stores the images captured by the cameras,

the system comprising:

a feature quantity calculation/detection unit that calculates a feature quantity of the subject from the feature point extracted by the feature point extraction unit;

a direction estimation unit that estimates a direction in which the subject is oriented from the feature point extracted by the feature point extraction unit; and

a stored camera image determination unit that determines a camera image to be stored in the image storage unit,

wherein

when a difference between the feature quantity calculated by the feature quantity calculation unit and a particular feature quantity set in advance is not more than a certain value, the stored camera image determination unit determines the image from which the feature point has been extracted by the plurality of the feature point extraction unit as a first stored image, and

determines a second stored image by identifying a camera in accordance with the direction in which the subject is oriented that has been estimated by the direction estimation unit from the feature point extracted in the first stored image.

The three cameras are adapted to capture the images in a direction in which the subject is photographed, a first direction in which the subject is watching, and a third direction different from the first direction. At the time of detection of a change in the feature quantity of the subject, it can be known what is drawing attention by utilizing the camera in the direction in which at least the feature quantity of the subject can be more readily detected between the first direction in which the subject is watching and the third direction different therefrom.

According to the above, it can be known what is being closely observed at the timing of sensing of a change in a particular feature quantity.

(2)

The image-capturing system according to (1), wherein the stored camera image determination unit, when the feature point is extracted by the feature point extraction unit in a plurality of camera images, determines, as the first stored image, the image in which the direction in which the subject is oriented as estimated by the direction estimation unit is closer to a front.

(3)

The image-capturing system according to (1) or (2), wherein the stored camera determination unit compares the direction in which the subject is oriented as estimated by the direction estimation unit and the direction of an optical axis of each of the cameras, and determines, as the second stored image, the image of the camera that minimizes an angle formed by the two directions, or the stored camera determination unit compares a feature point direction estimated by the feature point direction estimation unit and the direction of an optical axis of each of the cameras, and determines, as the second stored image, the image of the camera that minimizes the angle formed by the two directions.

In this way, the object of attention can be known more accurately.

(4)

The image-capturing system according to any one of (1) to (3), further including a distance calculation unit that, when a plurality of subjects are included in the images captured by the cameras, determines whether the same object of attention is being watched on the basis of a result estimated by the direction estimation unit, and calculates a distance from each subject to the object of attention,

wherein the second stored image is determined in accordance with the direction in which the subject of which the distance from each subject to the object of attention as calculated by the distance calculation unit is the farthest is oriented.

In this way, the object of attention can be known more accurately.

(5)

The image-capturing system according to (1), wherein, of the cameras that capture the images, at least one is a wide-angle camera having a wider angle of view than the other cameras, and

the stored camera image determination unit determines, as the second stored image, a part of the image captured by the wide-angle camera in accordance with the direction in which the subject is oriented as estimated by the direction estimation unit from the feature point extracted in the first stored image.

(6)

An information processing method using an image-capturing system including at least three cameras with different image-capturing directions, a feature point extraction unit that extracts a feature point of a subject from images captured by the cameras, and an image storage unit that stores the images captured by the cameras,

the method including:

a feature quantity calculating/detecting step of calculating a feature quantity of the subject from the feature point extracted by the feature point extraction unit;

a direction estimation step of estimating a direction in which the subject is oriented from the feature point extracted in the feature point extraction step; and

a stored camera image determination step of determining a camera image to be stored in the image storage unit,

wherein

when a difference between the feature quantity calculated in the feature quantity calculate step and a particular feature quantity set in advance is not more than a certain value, the stored camera image determination step determines, as a first stored image, the image from which the feature point has been extracted in the plurality of the feature point extract step, and

a second stored image is determined by identifying a camera in accordance with the direction in which the subject is oriented as estimated in the direction estimation step from the feature point extracted in the first stored image.

(7)

A program for causing a computer to execute the information processing method according to (6).

(8)

An information processing device comprising:

a feature quantity extraction unit that extracts a feature quantity of a subject from a feature point of the subject detected from first to third images with different image-capturing directions; and

a direction estimation unit that estimates a direction of the feature point detected by the feature point extraction unit,

wherein

when a difference between the feature quantity extracted by the feature quantity extraction unit and a particular feature quantity set in advance is not more than a certain value, the image from which the feature point has been extracted by the plurality of the feature point extraction unit is determined as a first image, and a second image is determined by identifying an image captured in accordance with a feature point direction estimated by the direction estimation unit from the feature point extracted in the first stored image.

### INDUSTRIAL APPLICABILITY

The present invention can be utilized in an image-capturing system.

### REFERENCE SIGNS LIST

100 Image-capturing system
101 First camera
102 Second camera
103 Third camera
110 Image acquisition unit
111 Face detection unit
112 Feature point extraction unit
113 Facial expression detection unit
114 Face direction estimation unit
115 Stored camera image determination unit
116 Parameter information storage unit
117 Image storage unit

All publications, patents, and patent applications cited in the present specification are incorporated herein by reference in their entirety.

1. An image-capturing system including at least three cameras with different image-capturing directions, a feature point extraction unit that extracts a feature point of a subject from images captured by the cameras, and an image storage unit that stores the images captured by the cameras,
the system comprising:
a feature quantity calculation/detection unit that calculates a feature quantity of the subject from the feature point extracted by the feature point extraction unit;
a direction estimation unit that estimates a direction in which the subject is oriented from the feature point extracted by the feature point extraction unit; and
a stored camera image determination unit that determines a camera image to be stored in the image storage unit,
wherein
when a difference between the feature quantity calculated by the feature quantity calculation/detection unit and a particular feature quantity set in advance is not more than a certain value, the stored camera image determination unit determines the image from which the feature point has been extracted as a first stored image, and
determines a second stored image by identifying a camera in accordance with the direction in which the subject is oriented that has been estimated by the direction estimation unit from the feature point extracted in the first stored image.

2. The image-capturing system according to claim 1, wherein the stored camera image determination unit, when the feature point is extracted by the feature point extraction unit in a plurality of camera images, determines, as the first stored image, the image in which the direction in which the subject is oriented as estimated by the direction estimation unit is closer to a front.

3. The image-capturing system according to claim 1, wherein the stored camera determination unit compares the direction in which the subject is oriented as estimated by the direction estimation unit and the direction of an optical axis of each of the cameras, and determines, as the second stored image, the image of the camera that minimizes an angle formed by the two directions, or the stored camera determination image unit compares a feature point direction estimated by the feature point direction estimation unit and the direction of an optical axis of each of the cameras, and determines, as the second stored image, the image of the camera that minimizes the angle formed by the two directions.

4. The image-capturing system according to claim 1, further including a distance calculation unit that, when a plurality of subjects are included in the images captured by the cameras, determines whether the same object of attention is being watched on the basis of a result estimated by the direction estimation unit, and calculates a distance from each subject to the object of attention,
wherein the second stored image is determined in accordance with the direction in which the subject of which the distance from each subject to the object of attention as calculated by the distance calculation unit is the farthest is oriented.

5. The image-capturing system according to claim 1, wherein, of the cameras that capture the images, at least one is a wide-angle camera having a wider angle of view than the other cameras, and
the stored camera image determination unit determines, as the second stored image, a part of the image captured by the wide-angle camera in accordance with the direction in which the subject is oriented as estimated by the direction estimation unit from the feature point extracted in the first stored image.

6. The image-capturing system according to claim 1, when a plurality of subjects are included in the images captured by the cameras, determines whether the same object of attention is being watched on the basis of a result estimated by the direction estimation unit,
wherein the second stored image is determined in accordance with the direction of one of the subject which watched the same object of attention is oriented.

7. An information processing method using an image-capturing system including at least three cameras with different image-capturing directions, a feature point extraction unit that extracts a feature point of a subject from images captured by the cameras, and an image storage unit that stores the images captured by the cameras,
the method including:
a feature quantity calculating/detecting step of calculating a feature quantity of the subject from the feature point extracted by the feature point extraction unit;
a direction estimation step of estimating a direction in which the subject is oriented from the feature point extracted by the feature point extraction unit; and
a stored camera image determination step of determining a camera image to be stored in the image storage unit,
wherein
when a difference between the feature quantity calculated in the feature quantity calculating/detecting step and a particular feature quantity set in advance is not more than a certain value, the stored camera image determination step determines, as a first stored image, the image from which the feature point has been extracted, and
a second stored image is determined by identifying a camera in accordance with the direction in which the subject is oriented as estimated in the direction estimation step from the feature point extracted in the first stored image.

8. A non-transitory computer-readable medium including a computer program for causing a computer to execute the information processing method according to claim 7.

9. An information processing device comprising:
a feature quantity extraction unit that extracts a feature quantity of a subject from a feature point of the subject detected from first to third images with different image-capturing directions; and
a direction estimation unit that estimates a direction of the feature point detected by a feature point extraction unit,
wherein
when a difference between the feature quantity extracted by the feature quantity extraction unit and a particular feature quantity set in advance is not more than a certain value, the image from which the feature point has been extracted is determined as a first image, and a second image is determined by identifying an image captured in accordance with a feature point direction estimated by the direction estimation unit from the feature point extracted in the first image.
